(19) United States
(12) Patent Application Publication
(10) Pub. No.: US 2014/0284523 A1
(43) Pub. Date: Sep. 25, 2014

(54) LIQUID CRYSTAL COMPOSITION AND LIQUID CRYSTAL DISPLAY DEVICE

(71) Applicants: JNC CORPORATION, Tokyo (JP); JNC PETROCHEMICAL CORPORATION, Tokyo (JP)

(72) Inventors: YOSHIMASA FURUSATO, CHIBA (JP); ERIKO KURIHARA, CHIBA (JP)

(73) Assignees: JNC PETROCHEMICAL CORPORATION, Tokyo (JP); JNC CORPORATION, Tokyo (JP)

(21) Appl. No.: 14/217,494

(22) Filed: Mar. 18, 2014

(30) Foreign Application Priority Data
Mar. 19, 2013 (JP) 2013-056995

(51) Int. Cl. C09K 19/34; C09K 19/30

(52) U.S. Cl. CPC C09K 19/3402; C09K 19/3003; C09K 19/3066; C09K 19/3068
USPC 252/299.61; 252/299.66; 252/299.63; 570/129

(57) ABSTRACT

A liquid crystal composition is described, which has a negative dielectric anisotropy and contains a specific compound having high stability to ultraviolet light as a first component, and may further contain a specific compound having a large negative dielectric anisotropy as a second component, a specific compound having a high maximum temperature or a small viscosity as a third component, and a specific compound having a polymerizable group as an additive component. An AM liquid crystal display device is also described, including the liquid crystal composition.

### CROSS-REFERENCE TO RELATED APPLICATION

This application claims priority benefits of Japan Patent Application No. 2013-056995, filed on Mar. 19, 2013. The entirety of the above-mentioned patent application is hereby incorporated by reference herein and made a part of this specification.

### TECHNICAL FIELD

The invention relates to a liquid crystal composition, a liquid crystal display device including the composition, and so forth. In particular, the invention relates to a liquid crystal composition having a negative dielectric anisotropy, and a liquid crystal display device that includes the composition and has a mode such as IPS, VA, FFS and FPA. The invention also relates to a liquid crystal display device having a polymer sustained alignment mode.

### BACKGROUND ART

For liquid crystal display devices, the classification based on an operating mode of liquid crystals includes a phase change (PC) mode, a twisted nematic (TN) mode, a super twisted nematic (STN) mode, an electrically controlled birefringence (ECB) mode, an optically compensated bend (OCB) mode, an in-plane switching (IPS) mode, a vertical alignment (VA) mode, a fringe field switching (FFS) mode, and a field-induced photo-reactive alignment (FPA) mode. The classification based on the driving mode of the device includes passive matrix (PM) and active matrix (AM) types. The PM types are classified into static type, multiplex type and so forth, and the AM types are classified into thin film transistor (TFT) types, metal insulator metal (MIM) types and so forth according to the type of the switching device. The TFT types are further classified into amorphous silicon and polycrystal silicon types according to the device-forming material, wherein the latter is further classified into a high temperature type and a low temperature type according to the production process. The classification based on the light source includes a reflective type utilizing natural light, a transmissive type utilizing a backlight, and a transflective type utilizing both the natural light and a backlight.

The devices include a liquid crystal composition having suitable characteristics. The liquid crystal composition has a nematic phase. To obtain an AM liquid crystal display device having good general characteristics, improvement of general characteristics of the composition is required. Table 1 below summarizes the relationship between the general characteristics of the two aspects. The general characteristics of the composition will be further explained based on a commercially available AM device. The temperature range of nematic phase relates to the temperature range in which the device can be used. A preferred maximum temperature of nematic phase is about 70° C. or higher and a preferred minimum temperature of nematic phase is about −10° C. or lower. The viscosity of the composition relates to the response time of the device. A short response time is preferred for displaying moving images on the device. A shorter response time even by one millisecond is desirable. Accordingly, a small viscosity of the composition is preferred. A small viscosity at a low temperature is further preferred.

TABLE 1
General Characteristics of Composition and AM Device

| | General Characteristics | General Characteristics |
|---|---|---|
| No. | of Composition | of AM Device |
| 1 | Wide temperature range of | Wide usable temperature range |
| | a nematic phase | |
| 2 | Small viscosity ¹⁾ | Short response time |
| 3 | Suitable optical anisotropy | Large contrast ratio |
| 4 | Large positive or negative | Low threshold voltage and small |
| | dielectric anisotropy | electric power consumption |
| | | Large contrast ratio |
| 5 | Large specific resistance | Large voltage holding ratio |
| | | and large contrast ratio |
| 6 | High stability to ultraviolet | Long service life |
| | light and heat | |

¹⁾ A liquid crystal composition can be injected into a liquid crystal cell in a shorter period of time.

The optical anisotropy of the composition relates to the contrast ratio of the device. According to the mode of the device, a large optical anisotropy or a small optical anisotropy, more specifically, a suitable optical anisotropy is required. The product (Δn×d) of the optical anisotropy (Δn) of the composition and the cell gap (d) of the device is designed so as to maximize the contrast ratio. A suitable value of the product depends on the type of the operating mode. The suitable value is the range of about 0.30 μm to about 0.40 μm for a device having a VA mode, or in the range of about 0.20 μm to about 0.30 μm for a device having an IPS mode or a FFS mode. In the above cases, a composition having a large optical anisotropy is preferred for a device having a small cell gap. A large dielectric anisotropy of the composition contributes to a low threshold voltage, a small electric power consumption and a large contrast ratio of the device. Accordingly, a large dielectric anisotropy is preferred. A large specific resistance of the composition contributes to a large voltage holding ratio and a large contrast ratio of the device. Accordingly, a composition having a large specific resistance at room temperature and also at a high temperature in an initial stage is preferred. A composition having a large specific resistance at room temperature and also at a high temperature even after the device has been used for a long period of time is preferred. The stability of the composition to ultraviolet light and heat relates to the service life of the liquid crystal display device. In a case where the stability is high, the device has a long service life. Such characteristics are preferred for an AM device for use in a liquid crystal projector, a liquid crystal television and so forth.

In a liquid crystal display device having a polymer sustained alignment (PSA) mode, a liquid crystal composition containing a polymer is used. First, a composition to which a small amount of polymerizable compound is injected into the device. Next, while a voltage is applied between substrates of the device, the composition is irradiated with ultraviolet light. The polymerizable compound polymerizes to produce a network structure of the polymer in the composition. In the composition, a control of alignment of liquid crystal molecules is allowed by the polymer, and therefore the response time of the device is shortened and image sticking is improved. Such an effect of the polymer can be expected for a device having a mode such as TN, ECB, OCB, IPS, VA, FFS or FPA.

A composition having a positive dielectric anisotropy is used for an AM device having a TN mode. A composition having a negative dielectric anisotropy is used for an AM device having a VA mode. A composition having a positive or negative dielectric anisotropy is used for an AM device having an IPS mode, a FFS mode or a FPA mode. Examples of a liquid crystal composition having a first component of the invention are disclosed in Patent Literature Nos. 1 and 2. Examples of a composition for a polymer sustained alignment mode device are disclosed in Patent Literature No. 3.

### CITATION LIST

### Patent Literature

Patent Literature No. 1: DE 102010025572 A1.

Patent Literature No. 2: WO 2011-009524 A.

Patent Literature No. 3: WO 2011-029510 A.

### SUMMARY OF INVENTION

Accordingly, the invention provides a liquid crystal composition satisfying at least one of characteristics such as a high maximum temperature of nematic phase, a low minimum temperature of nematic phase, a small viscosity, a suitable optical anisotropy, a large negative dielectric anisotropy, a large specific resistance, a high stability to UV light and a high stability to heat. The invention also provides a liquid crystal composition having a suitable balance between at least two of the characteristics. The invention further provides a liquid crystal display device including such a composition. The invention additionally provides an AM device having characteristics such as a short response time, a large voltage holding ratio, a low threshold voltage, a large contrast ratio and a long service life.

The invention concerns a liquid crystal composition that has a negative dielectric anisotropy, and contains at least one compound selected from the group of compounds represented by formula (1) as a first component, and also concerns a liquid crystal display device including the composition:

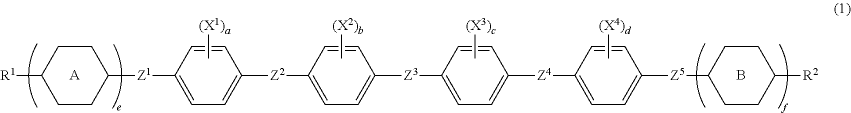

wherein in formula (1), R¹ and R² are independently alkyl having 1 to 12 carbons, alkoxy having 1 to 12 carbons, alkenyl having 2 to 12 carbons, or alkenyl having 2 to 12 carbons in which at least one hydrogen is replaced by fluorine; ring A and ring B are independently 1,4-phenylene, 1,4-cyclohexylene, 1,4-cyclohexenylene, 1,3-dioxane-2,5-diyl, tetrahydropyran-2,5-diyl, or 1,4-phenylene in which at least one hydrogen is replaced by fluorine, chlorine or methyl; X¹, X², X³ and X⁴ are independently fluorine, chlorine or methyl; Z¹, Z², Z³, Z⁴ and Z⁵ are independently a single bond, —CH₂CH₂—, —CH₂O—, —OCH₂—, —COO— or —OCO—; a, b, c and d are independently 0, 1, 2, 3 or 4; and e and f are independently 0 or 1.

The invention also concerns a compound represented by formula (1-2) or formula (1-3):

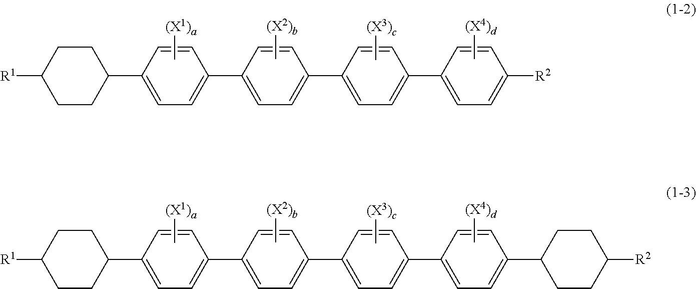

wherein in formula (1-2) and formula (1-3), R¹ and R² are independently alkyl having 1 to 12 carbons, alkoxy having 1 to 12 carbons, alkenyl having 2 to 12 carbons, or alkenyl having 2 to 12 carbons in which at least one hydrogen is replaced by fluorine; X¹, X², X³ and X⁴ are independently fluorine, chlorine or methyl; and a, b, c and d are independently 0, 1, 2, 3 or 4.

The invention also concerns a liquid crystal display device including the liquid crystal composition.

The invention further concerns a liquid crystal display device having a polymer sustained alignment mode, which contains the liquid crystal composition in which a polymerizable compound added therein has been polymerized.

The invention still further concerns use of the liquid crystal composition in a liquid crystal display device.

The liquid crystal composition of the invention satisfies at least one of characteristics such as a high maximum temperature of nematic phase, a low minimum temperature of nematic phase, a small viscosity, a suitable optical anisotropy, a large negative dielectric anisotropy, a large specific resistance, a high stability to UV light, and a high stability to heat. The liquid crystal composition of the invention may have a suitable balance between at least two of the characteristics. The AM liquid crystal display device of the invention includes such a composition, therefore having characteristics such as a short response time, a large voltage holding ratio, a low threshold voltage, a large contrast ratio and a long service life.

### DESCRIPTION OF EMBODIMENTS

The usage of terms herein is described below. The terms “liquid crystal composition” and “liquid crystal display device” may be occasionally abbreviated as “composition” and “device,” respectively. The liquid crystal display device is a generic term for a liquid crystal display panel and a liquid crystal display module. A liquid crystal compound is a generic term for a compound having a liquid crystal phase such as a nematic phase and a smectic phase, and a compound having no liquid crystal phase but to be mixed with the composition for the purpose of adjusting characteristics such as the temperature range of nematic phase, viscosity and dielectric anisotropy. Such a compound has a six-membered ring such as 1,4-cyclohexylene and 1,4-phenylene, and a rod-like molecular structure. A polymerizable compound is added for the purpose of producing a polymer in the composition. At least one compound selected from the group of compounds represented by formula (1) may be occasionally abbreviated as “compound (1).” “Compound (1)” means one compound or two or more compounds represented by formula (1).

The liquid crystal composition is prepared by mixing a plurality of liquid crystal compounds. A proportion (content) of the liquid crystal compound is expressed in terms of weight percent (wt %) based on the weight of the liquid crystal composition. To the composition, an additive such as an optically active compound, an antioxidant, an ultraviolet light absorber, a dye, an antifoaming agent, a polymerizable compound, a polymerization initiator or a polymerization inhibitor is added when necessary. The proportion of addition (addition amount) of the additive is expressed in terms of weight percent (wt %) based on the weight of the liquid crystal composition before addition. Weight parts per million (ppm) may also occasionally be used. The proportion of the polymerization initiator and the polymerization inhibitor is exceptionally expressed based on the total weight of the polymerizable compound.

“Maximum temperature of the nematic phase” may be occasionally abbreviated as “maximum temperature.” “Minimum temperature of the nematic phase” may be occasionally abbreviated as “minimum temperature.” The expression “having a large specific resistance” means that a composition has a large specific resistance at room temperature and also at a temperature close to the maximum temperature of nematic phase in an initial stage, and that the composition has a large specific resistance at room temperature and also at a temperature close to the maximum temperature of nematic phase even after the device has been used for a long period of time. The expression “having a large voltage holding ratio” means that a device has a large voltage holding ratio at room temperature and also at a high temperature in an initial stage, and that the device has a large voltage holding ratio at room temperature and also at a temperature close to the maximum temperature of nematic phase even after the device has been used for a long period of time. The expression “increasing dielectric anisotropy” means that a value thereof positively increases in a case of a composition having a positive dielectric anisotropy, and that the value thereof negatively increases in a case of a composition having a negative dielectric anisotropy.

The expression “at least one of ‘A’ may be replaced by ‘B’” means that the number of ‘A’ is arbitrary. When the number of ‘A’ is one, the position of ‘A’ is arbitrary, and also when the number of ‘A’ is two or more, the positions thereof can be selected without restriction. The same rule also applies to the expression “at least one of ‘A’ is replaced by ‘B’.”

The symbol R¹ of a terminal group is used for a plurality of compounds in chemical formulas of component compounds. In the compounds, two groups represented by arbitrary two R¹ may be identical or different. In one case, for example, R¹ of compound (1-1) is ethyl and R¹ of compound (1-2) is ethyl. In another case, R¹ of compound (1-1) is ethyl and R¹ of compound (1-2) is propyl. The same rule also applies to a symbol of any other terminal group or the like. When g is 2 in formula (2), two rings C exist. In the compound, two groups represented by two rings C may be identical or different. The same rule also applies to two of arbitrary ring C when g is larger than 2. The same rule also applies also to the symbol of any other ring, bonding group or the like.

A perpendicular line crossing a hexagon in a phenylene ring of compound (1) means that a position on which hydrogen on a six-membered ring is replaced by a group such as X¹ can be arbitrarily selected. A subscript such as a and b represents the number of groups involved in replacement. An oblique line traversing a hexagon in ring G of compound (4) means that a position on which hydrogen on a six-membered ring is replaced by a substituent such as P¹-Sp¹ can be arbitrarily selected. A subscript such as k represents the number of groups involved in replacement. The same rule also applies to F (fluorine) that is a group involved in replacement in compound (1-2a).

Then, 2-fluoro-1,4-phenylene means two divalent groups described below. In the chemical formula, fluorine may be leftward (L) or rightward (R). The same rule also applies to an asymmetric divalent ring such as tetrahydropyran-2,5-diyl.

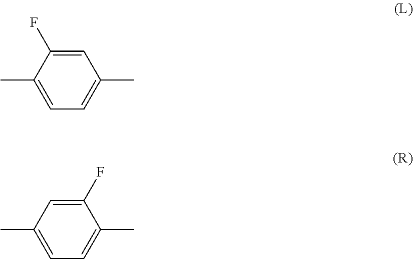

The invention includes the items described below.

Item 1 is a liquid crystal composition that has a negative dielectric anisotropy and contains at least one compound selected from the group of compounds represented by formula (1) as a first component:

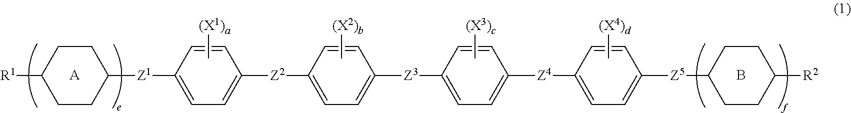

wherein in formula (1), R¹ and R² are independently alkyl having 1 to 12 carbons, alkoxy having 1 to 12 carbons, alkenyl having 2 to 12 carbons, or alkenyl having 2 to 12 carbons in which at least one hydrogen is replaced by fluorine; ring A and ring B are independently 1,4-phenylene, 1,4-cyclohexylene, 1,4-cyclohexenylene, 1,3-dioxane-2,5-diyl, tetrahydropyran-2,5-diyl, or 1,4-phenylene in which at least one hydrogen is replaced by fluorine, chlorine or methyl; X¹, X², X³ and X⁴ are independently fluorine, chlorine or methyl; Z¹, Z², Z³, Z⁴ and Z⁵ are independently a single bond, —CH₂CH₂—, —CH₂O—, —OCH₂—, —COO— or —OCO—; a, b, c and d are independently 0, 1, 2, 3 or 4; and e and f are independently 0 or 1.

Item 2 is the liquid crystal composition of item 1 which contains at least one compound selected from the group of compounds represented by formula (1-1) to formula (1-3) as the first component:

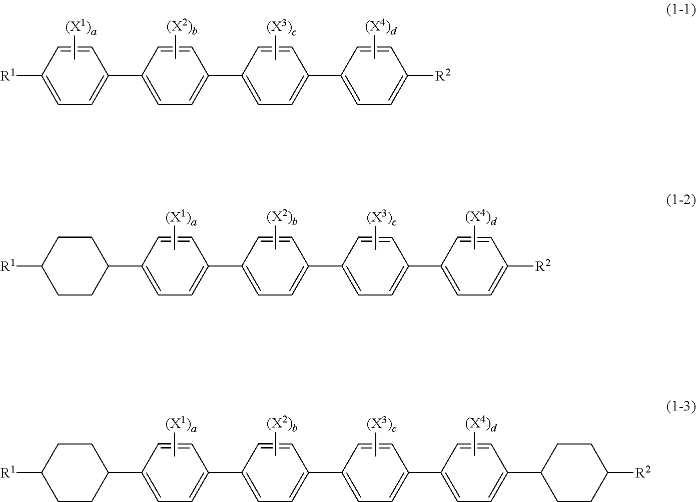

wherein in formula (1-1) to formula (1-3), R¹ and R² are independently alkyl having 1 to 12 carbons, alkoxy having 1 to 12 carbons, alkenyl having 2 to 12 carbons, or alkenyl having 2 to 12 carbons in which at least one hydrogen is replaced by fluorine; X¹, X², X³ and X⁴ are independently fluorine, chlorine or methyl; and a, b, c and d are independently 0, 1, 2, 3 or 4.

Item 3 is the liquid crystal composition of item 1 or 2 which contains at least one compound selected from the group of compounds represented by formula (1-1-1) to formula (1-1-8), formula (1-2-1), formula (1-2-2) and formula (1-3-1) as the first component:

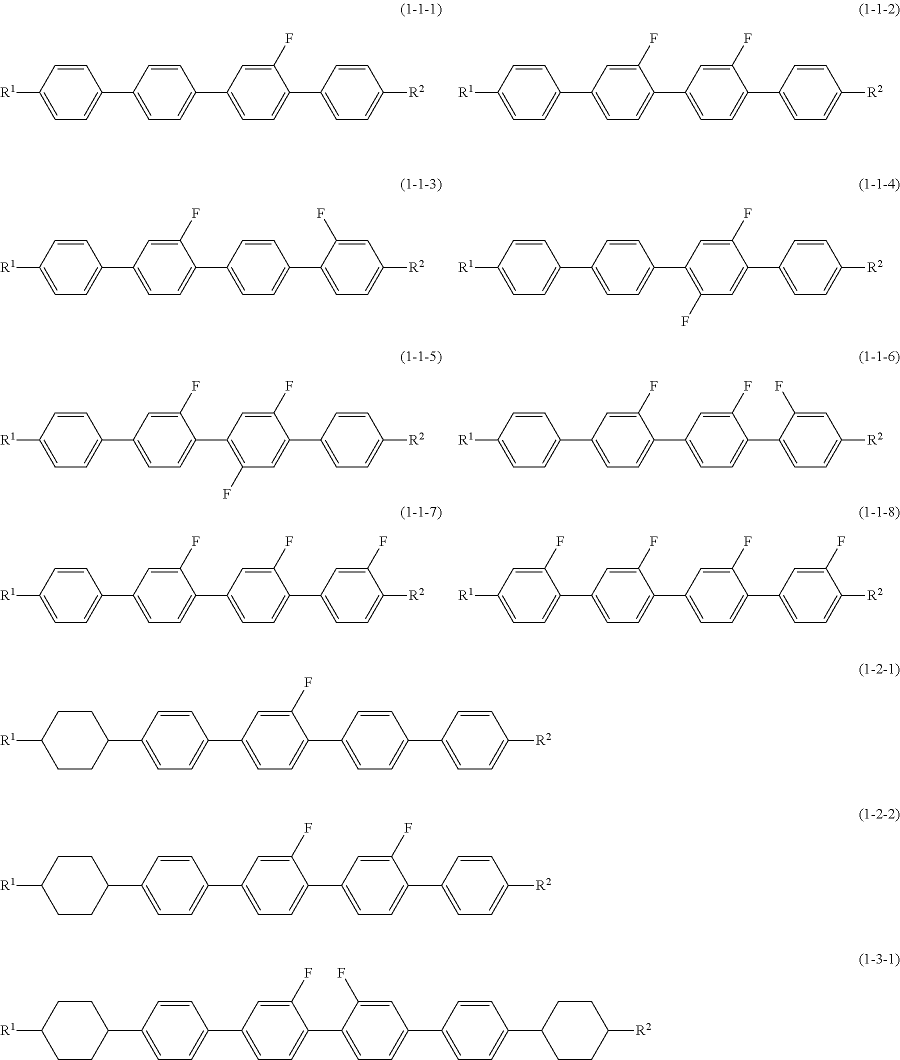

wherein in formulas (1-1-1) to formula (1-1-8), (1-2-1), (1-2-2) and (1-3-1), R¹ and R² are independently alkyl having 1 to 12 carbons, alkoxy having 1 to 12 carbons, alkenyl having 2 to 12 carbons, or alkenyl having 2 to 12 carbons in which at least one hydrogen is replaced by fluorine.

Item 4 is the liquid crystal composition of any one of items 1 to 3 in which the proportion of the first component is in the range of 0.03 wt % to 10 wt % based on the weight of the liquid crystal composition.

Item 5 is the liquid crystal composition of any one of items 1 to 4 which contains at least one compound selected from the group of compounds represented by formula (2) as a second component:

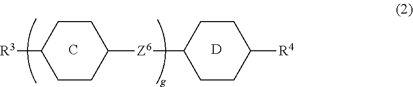

wherein in formula (2), R³ and R⁴ are independently alkyl having 1 to 12 carbons, alkoxy having 1 to 12 carbons, alkenyl having 2 to 12 carbons, or alkenyloxy having 2 to 12 carbons; ring C is 1,4-cyclohexylene, tetrahydropyran-2,5-diyl, 1,4-phenylene, or 1,4-phenylene in which at least one hydrogen is replaced by fluorine or chlorine; ring D is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl or 7,8-difluorochroman-2,6-diyl; Z⁶ is a single bond, —CH₂CH₂—, —CH₂O—, —OCH₂—, —COO— or —OCO—; and g is 1, 2 or 3, and when g is 3, ring C is 1,4-cyclohexylene or tetrahydropyran-2,5-diyl.

Item 6 is the liquid crystal composition of any one of items 1 to 5 which contains at least one compound selected from the group of compounds represented by formula (2-1) to formula (2-18) as the second component:

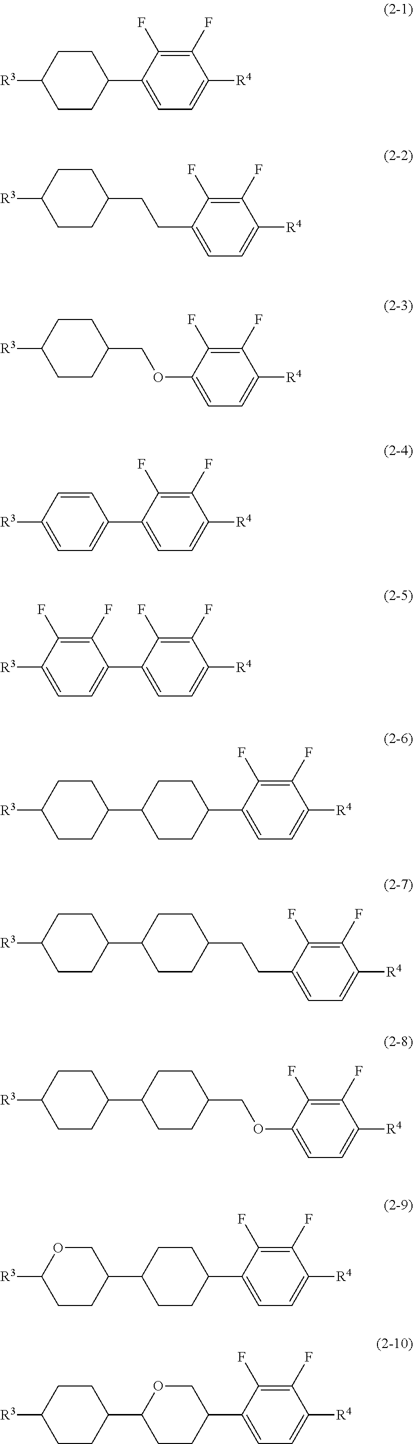

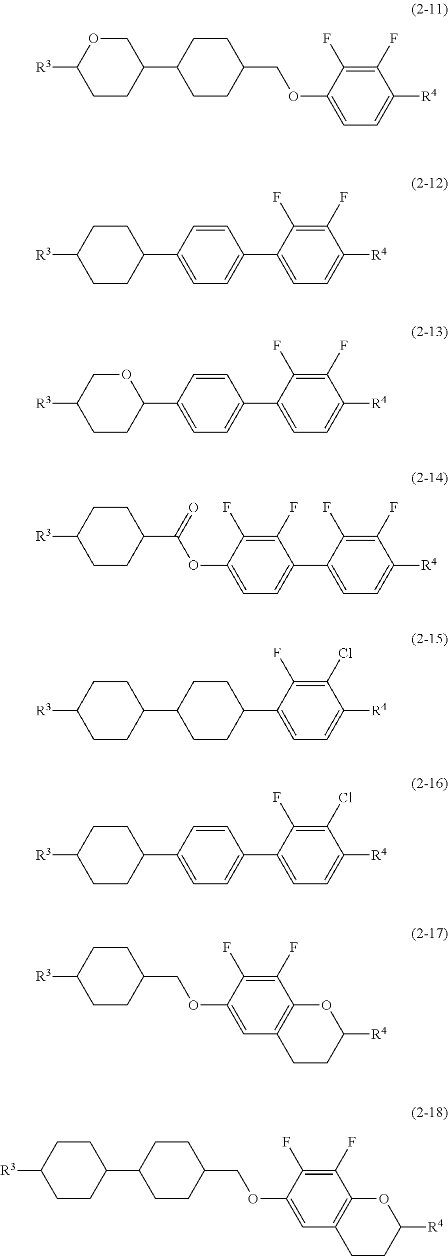

wherein in formula (2-1) to formula (2-18), R³ and R⁴ are independently alkyl having 1 to 12 carbons, alkoxy having 1 to 12 carbons, alkenyl having 2 to 12 carbons, or alkenyloxy having 2 to 12 carbons.

Item 7 is the liquid crystal composition of item 5 or 6 in which the proportion of the second component is in the range of 10 wt % to 90 wt % based on the weight of the liquid crystal composition.

Item 8 is the liquid crystal composition of any one of items 1 to 7 which contains at least one compound selected from the group of compounds represented by formula (3) as a third component:

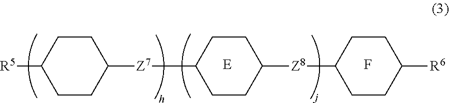

wherein in formula (3), R⁵ and R⁶ are independently alkyl having 1 to 12 carbons, alkoxy having 1 to 12 carbons, alkenyl having 2 to 12 carbons, or alkenyl having 2 to 12 carbons in which at least one hydrogen is replaced by fluorine; ring E and ring F are independently 1,4-cyclohexylene, 1,4-phenylene or 2-fluoro-1,4-phenylene; Z⁷ and Z⁸ are independently a single bond, —CH₂CH₂—, —CH₂O—, —OCH₂—, —COO— or —OCO—; h is 0 or 1; and j is 1 or 2.

Item 9 is the liquid crystal composition of any one of items 1 to 8 which contains at least one compound selected from the group of compounds represented by formula (3-1) to formula (3-13) as the third component:

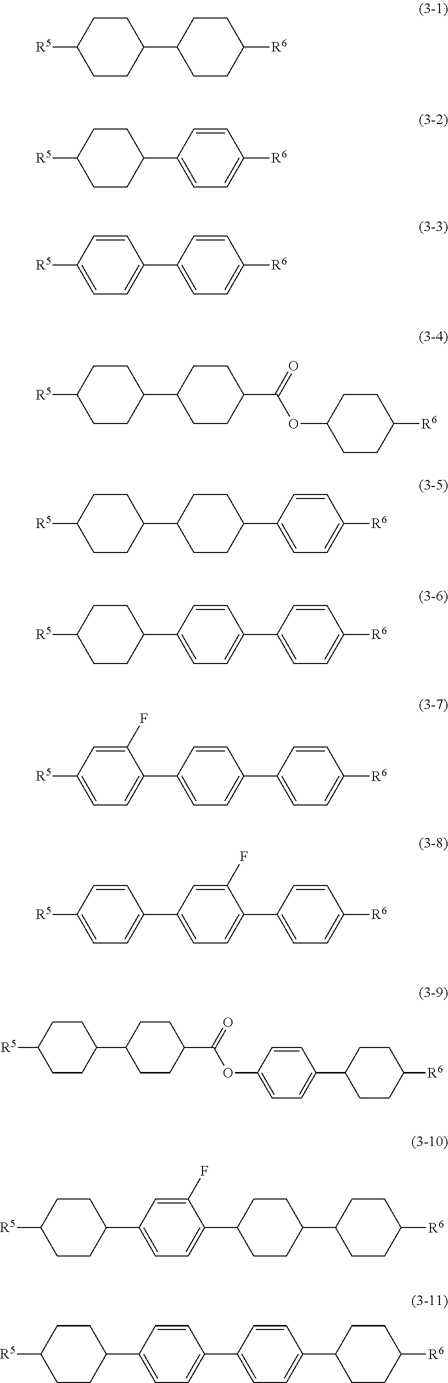

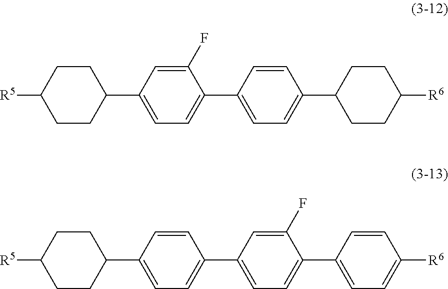

wherein in formula (3-1) to formula (3-13), R⁵ and R⁶ are independently alkyl having 1 to 12 carbons, alkoxy having 1 to 12 carbons, alkenyl having 2 to 12 carbons, or alkenyl having 2 to 12 carbons in which at least one hydrogen is replaced by fluorine.

Item 10 is the liquid crystal composition of item 8 or 9 in which the proportion of the third component is in the range of 10 wt % to 90 wt % based on the weight of the liquid crystal composition.

Item 11 is the liquid crystal composition of any one of items 1 to 10 which contains at least one polymerizable compound selected from the group of compounds represented by formula (4) as an additive component:

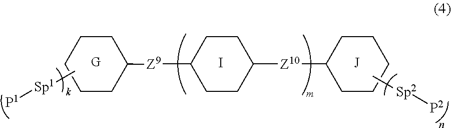

wherein in formula (4), P¹ and P² are independently a polymerizable group selected from the group of groups represented by formula (P-1), formula (P-2) and formula (P-3);

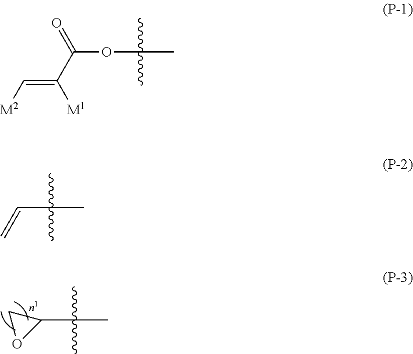

wherein in formula (P-1), M¹ and M² are independently hydrogen, fluorine, methyl or trifluoromethyl;
in formula (P-3), n¹ is 1, 2, 3 or 4; Sp¹ and Sp² are independently a single bond or alkylene having 1 to 12 carbons, and in the alkylene, at least one —CH₂— may be replaced by —O—, —S—, —NH—, —CO—, —COO—, —OCO— or —OCOO—, at least one —CH₂—CH₂— may be replaced by —CH═CH— or —C≡C—, and at least one hydrogen may be replaced by halogen or —C≡N; Z⁹ is a single bond, —CH₂CH₂—, —CH₂O—, —OCH₂—, —COO—, —OCO—, —CO—CR⁷═CR⁸—, —CR⁸═CR⁷—CO—, —OCO—CR⁷═CR⁸—, —CR⁸═CR⁷—COO—, —CR⁷═CR⁸— or —C(═CR⁷R⁸)—; Z¹⁰ is a single bond, —CH₂CH₂—, —CH₂O—, —OCH₂—, —COO— or —OCO—; R⁷ and R⁸ are independently hydrogen, halogen, alkyl having 1 to 10 carbons, or alkyl having 1 to 10 carbons in which at least one hydrogen is replaced by fluorine; ring G and ring J are independently cyclohexyl, phenyl, 2-fluorophenyl, 3-fluorophenyl, 2,3-difluorophenyl, 2-methylphenyl, 3-methylphenyl, 2-(trifluoromethyl)phenyl, 3-(trifluoromethyl)phenyl or 2-naphthyl; ring I is 1,4-cyclohexylene, 1,4-phenylene, naphthalene-2,6-diyl, 2-fluoro-1,4-phenylene, 2,3-difluoro-1,4-phenylene, 2,5-difluoro-1,4-phenylene, 2-methyl-1,4-phenylene or 2-trifluoromethyl-1,4-phenylene; m is 0, 1 or 2; k is 1, 2 or 3; n is 1, 2 or 3, and the sum of k and n is 4 or less; and when both P¹ and P² are a group represented by formula (P-2), at least one of Sp¹ and Sp² is alkylene in which at least one —CH₂— is replaced by —O—, —COO—, —OCO— or —OCOO—.

Item 12 is the liquid crystal composition of any one of items 1 to 11 which contains at least one polymerizable compound selected from the group of compounds represented by formula (4-1) to formula (4-26) as the additive component:

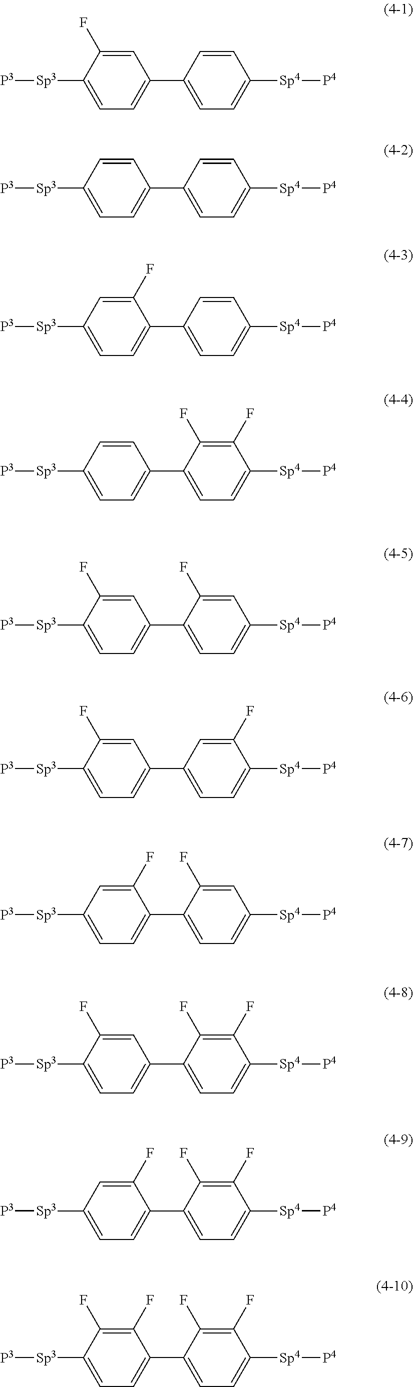

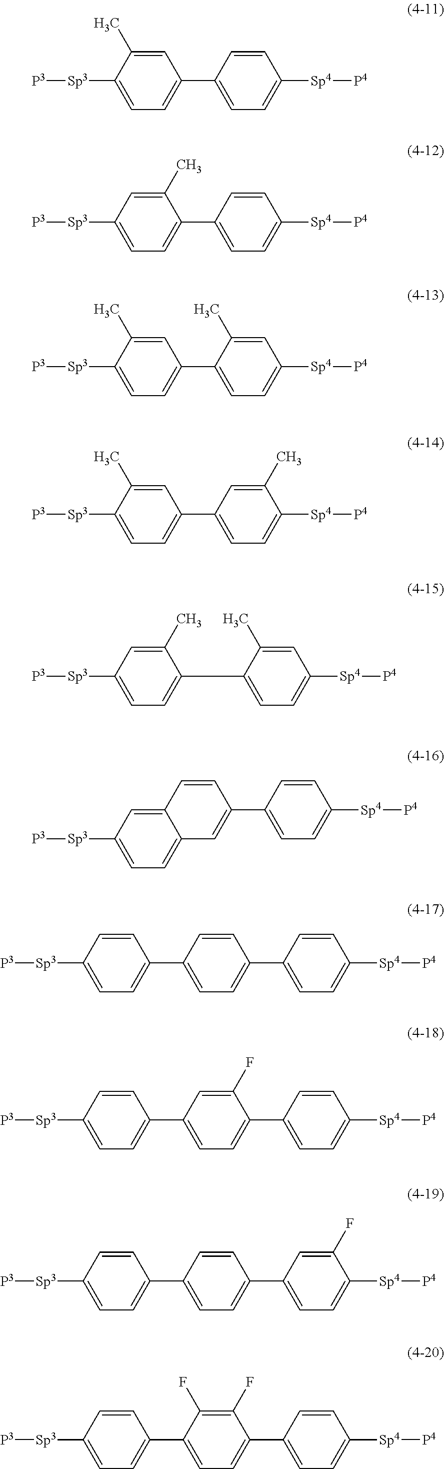

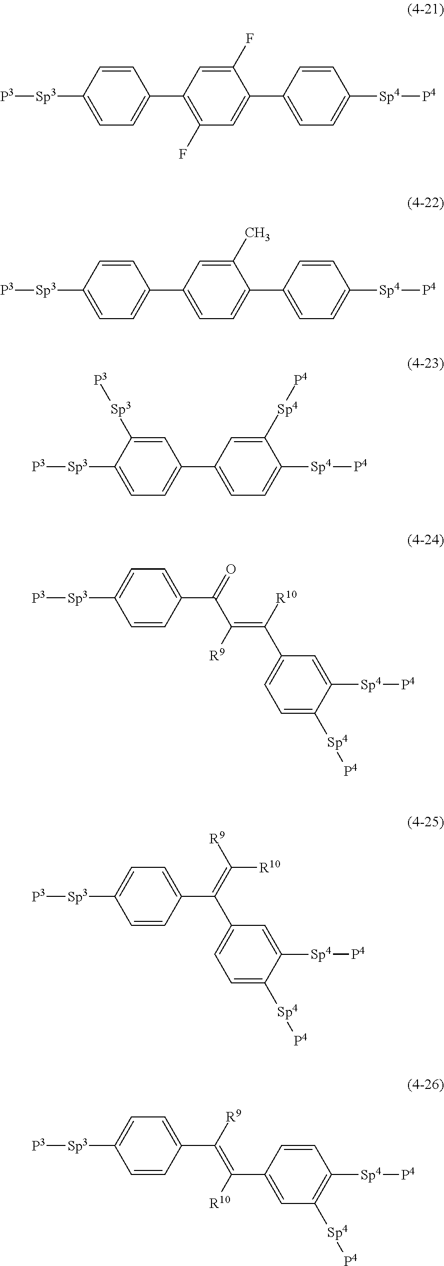

wherein in formula (4-1) to formula (4-26), P³ and P⁴ are independently a group represented by (P-1);

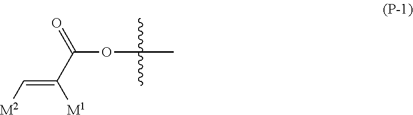

wherein in formula (P-1), M¹ and M² are independently hydrogen, fluorine, methyl or trifluoromethyl; Sp³ and Sp⁴ are independently a single bond or alkylene having 1 to 12 carbons, and in the alkylene, at least one —CH₂— may be replaced by —O—, —COO—, —OCO— or —OCOO—, at least one —CH₂—CH₂— may be replaced by —CH═CH— or —C≡C—, and at least one hydrogen may be replaced by fluorine or chlorine; and R⁹ and R¹⁰ are independently hydrogen, fluorine, chlorine, alkyl having 1 to 3 carbons, or alkyl having 1 to 3 carbons in which at least one hydrogen is replaced by fluorine.

Item 13 is the liquid crystal composition of item 11 or 12 in which the proportion of addition of the additive component is in the range of 0.03 wt % to 10 wt % based on the weight of the liquid crystal composition before addition.

Item 14 is a compound represented by formula (1-2) or formula (1-3):

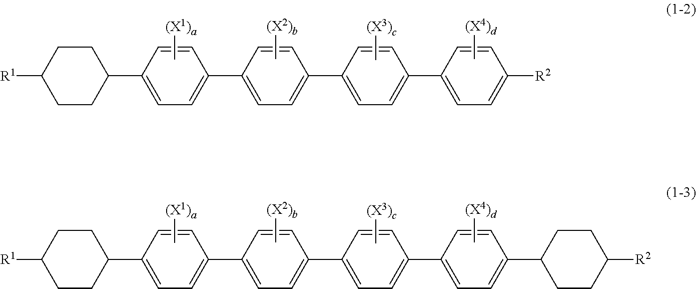

wherein in formula (1-2) and formula (1-3), R¹ and R² are independently alkyl having 1 to 12 carbons, alkoxy having 1 to 12 carbons, alkenyl having 2 to 12 carbons, or alkenyl having 2 to 12 carbons in which at least one hydrogen is replaced by fluorine; X¹, X², X³ and X⁴ are independently fluorine, chlorine or methyl; and a, b, c and d are independently 0, 1, 2, 3 or 4.

Item 15 is a liquid crystal display device including the liquid crystal composition of any one of items 1 to 13.

Item 16 is the liquid crystal display device of item 15 of which the operating mode is an IPS mode, a VA mode, an FFS mode or an FPA mode, and the driving mode in the liquid crystal display device is an active matrix mode.

Item 17 is a liquid crystal display device having a polymer sustained alignment mode, which contains the liquid crystal composition of any one of items 11 to 13 in which the polymerizable compound in the liquid crystal composition has been polymerized.

Item 18 is use of the liquid crystal composition of any one of items 1 to 13 in a liquid crystal display device.

Item 19 is use of the liquid crystal composition of any one of items 1 to 13 in a liquid crystal display device having a polymer sustained alignment mode.

The invention also includes the following items: a) a method for manufacturing the liquid crystal display device by arranging the liquid crystal composition between two substrates, irradiating the composition with light in a state in which a voltage is applied to the composition, and polymerizing a polymerizable compound contained in the composition; and b) the liquid crystal composition, wherein the maximum temperatures of nematic phase is 70° C. or higher, the optical anisotropy (measured at 25° C.) at a wavelength of 589 nanometers is 0.08 or more, and the dielectric anisotropy (measured at 25° C.) at a frequency of 1 kHz is −2 or less.

The invention further includes the following items: c) the above composition further containing at least one compound selected from the group of compounds being compounds (5) to (7) as a liquid crystal compound having a positive dielectric anisotropy as described in JP 2006-199941 A; d) the above composition containing polymerizable compound (4) described above; e) the above composition containing a polymerizable compound different from polymerizable compound (4); f) the above composition further containing at least one additive such as an optically active compound, an antioxidant, an ultraviolet light absorber, a dye, an antifoaming agent, a polymerization initiator and a polymerization inhibitor; g) an AM device including the composition; h) a device including the composition and having a TN, ECB, OCB, IPS, FFS, VA or FPA mode; a transmissive device including the composition; j) use of the composition as a composition having a nematic phase; and k) use as an optically active composition by adding the optically active compound to the composition.

The invention also includes the following item: 1) a compound represented by formula (1-2a) or formula (1-3a):

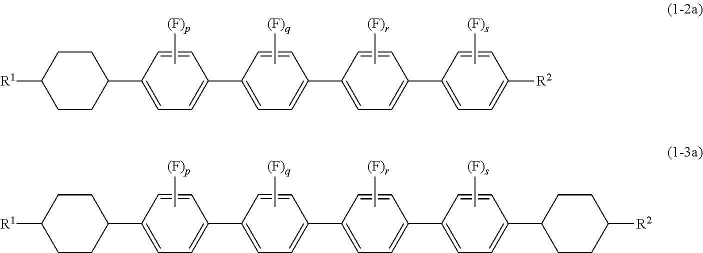

wherein in formula (1-2a) and formula (1-3a), R¹ and R² are independently alkyl having 1 to 12 carbons, alkoxy having 1 to 12 carbons, alkenyl having 2 to 12 carbons, or alkenyl having 2 to 12 carbons in which at least one hydrogen is replaced by fluorine; p, q, r and s are independently 0, 1 or 2, and the sum of p, q, r and s is 1 to 5; m) in formula (1-2a) and formula (1-3a), p, q, r and are independently 0, 1 or 2, and the sum of p, q, r and s is 1 to 3; n) in formula (1-2a) and formula (1-3a), p, q, r and s are independently 0, 1 or 2, and the sum of p, q, r and s is 3 to 5; o) a compound represented by formula (1-2-1); p) the compound represented by formula (1-2-2); and q) the compound represented by formula (1-3-1).

The composition of the invention will be explained in the following order. First, the constitution of the component compounds in the composition is explained. Second, the main characteristics of the component compounds and the main effects of the compounds on the composition are explained. Third, the combination of components in the composition, preferred proportion of the component compounds and the bases thereof are explained. Fourth, a preferred embodiment of the component compounds is explained. Fifth, specific examples of the component compounds are shown. Sixth, additives that may be mixed with the composition are explained. Seventh, methods for synthesizing the component compounds are explained. Last, the application of the composition are explained.

First, the constitution of the component compounds in the composition is explained. The compositions of the invention are classified into composition A and composition B. Composition A may further contain any other liquid crystal compound, any other additive or the like in addition to the liquid crystal compound selected from compounds (1), (2), (3) and (4). “Any other liquid crystal compound” means a liquid crystal compound different from compound (1), (2), (3) and (4). Such a compound is mixed with the composition for the purpose of further adjusting the characteristics. Among other liquid crystal compounds, the amount of a cyano compound is preferably as small as possible in view of the stability to heat or ultraviolet light. A further preferred proportion of the cyano compound is 0 wt %. The additives include an optically active compound, an antioxidant, an ultraviolet light absorber, a dye, an antifoaming agent, a polymerizable compound, a polymerization initiator and a polymerization inhibitor.

Composition B consists essentially of compounds selected from the group of compounds (1), (2), (3) and (4). The term “essentially” means that the composition may contain any other additive but does not contain a liquid crystal compound different from compounds (1), (2), (3) and (4). Composition B has a smaller number of components than composition A has. Composition B is preferred to composition A in view of cost reduction. Composition A is preferred to composition B in view of the possibility of further adjusting physical properties by mixing any other liquid crystal compound.

Second, the main characteristics of the component compounds and the main effects of the compounds on the characteristics of the composition are explained. The main characteristics of the component compounds are summarized in Table 2 on the basis of advantageous effects of the invention. In Table 2, the symbol L stands for “large” or “high,” the symbol M stands for “medium,” and the symbol S stands for “small” or “low.” The symbols L, M and S represent a classification based on a qualitative comparison between the component compounds, and 0 (zero) means “the value is nearly zero.”

TABLE 2
Characteristics of Compounds

| Compounds | Compound (1) | Compound (2) | Compound (3) |
|---|---|---|---|
| Maximum temperature | L | S to M | S to L |
| Viscosity | L | L | S to M |
| Optical anisotropy | L | M to L | S to L |
| Dielectric anisotropy | S to M | L¹⁾ | 0 |
| Specific resistance | L | L | L |

¹⁾A value of dielectric anisotropy is negative, and a symbol indicates magnitude of an absolute value.

Upon mixing the component compounds with the composition, the main effects of the component compounds on the characteristics of the composition are as described below. Compound (1) maintains a high stability to ultraviolet light. Compound (2) increases the dielectric anisotropy and decreases the minimum temperature. Compound (3) decreases the viscosity or increases the maximum temperature. Compound (4) gives a polymer by polymerization, the polymer shortening the response time of the device and reduces the image sticking.

Third, the combination of the components in the composition, the preferred proportions of the component compounds and the bases thereof are explained. The combinations of the components in the composition include a combination of the first component and the second component, a combination of the first component, the second component and the third component, a combination of the first component, the second component and the additive component, and a combination of the first component, the second component, the third component and the additive component. Preferred combinations of the components include a combination of the first component, the second component and the third component, and a combination of the first component, the second component, the third component and the additive component.

A preferred proportion of the first component is, based on the weight of the liquid crystal composition, about 0.03 wt % or more for maintaining a high stability to ultraviolet light, and about 10 wt % or less for decreasing the minimum temperature. A further preferred proportion is in the range of about 0.1 wt % to about 2 wt %. A particularly preferred proportion is in the range of about 0.3 wt % to about 1.5 wt %.

A preferred proportion of the second component is, based on the weight of the liquid crystal composition, about 10 wt % or more for increasing the dielectric anisotropy, and about 90 wt % or less for decreasing the viscosity. A further preferred proportion is in the range of about 20 wt % to about 80 wt %. A particularly preferred proportion is in the range of about 30 wt % to about 70 wt %.

A preferred proportion of the third component is, based on the weight of the liquid crystal composition, about 10 wt % or more for increasing the maximum temperature or decreasing the viscosity, and about 90% or less for decreasing the minimum temperature. A further preferred proportion is in the range of about 20 wt % to about 80 wt %. A particularly preferred proportion is in the range of about 30 wt % to about 70 wt %.

Compound (4) is added to the composition for the purpose of adapting the composition for a device having a polymer sustained alignment mode. A preferred proportion of addition of the additive is, based on the weight of the liquid crystal composition before addition, about 0.03 wt % or more for aligning liquid crystal molecules, and 10 wt % or less for preventing a poor display. A further preferred proportion of addition is in the range of about 0.1 wt % to about 2 wt %. A particularly preferred proportion of addition is in the range of about 0.2 wt % to about 1.0 wt %.

The characteristics of the composition as described in Table 1 can be adjusted by adjusting the proportions of the component compounds. The characteristics may also be adjusted by mixing any other liquid crystal compound when necessary. A composition having a maximum temperature of about 70° C. or higher can be prepared by such a method. A composition having a maximum temperature of about 75° C. or higher can also be prepared. A composition having a maximum temperature of about 80° C. or higher can also be prepared. A composition having a minimum temperature of about −10° C. or lower can be prepared by such a method. A composition having a minimum temperature of about −20° C. or lower can also be prepared. A composition having a minimum temperature of about −30° C. or lower can also be prepared.

A composition having an optical anisotropy (measured at 25° C.) in the range of about 0.09 to about 0.12 at a wavelength of 589 nm can be prepared by such a method. A composition having an optical anisotropy (measured at 25° C.) in the range of about 0.08 to about 0.16 at a wavelength of 589 nm can also be prepared. A composition having an optical anisotropy (measured at 25° C.) in the range of about 0.07 to about 0.20 can at a wavelength of 589 nm also be prepared. A composition having a dielectric anisotropy (measured at 25° C.) in the range of about −1.5 or less at a frequency of 1 kHz can be prepared by such a method. A composition having a dielectric anisotropy (measured at 25° C.) in the range of about −2.0 or less at a frequency of 1 kHz can also be prepared. A composition having a dielectric anisotropy (measured at 25° C.) in the range of about −2.5 or less at a frequency of 1 kHz can also be prepared.

Fourth, preferred embodiments of the component compounds are explained. In compounds (1) to (3), R¹, R², R⁵ and R⁶ are independently alkyl having 1 to 12 carbons, alkoxy having 1 to 12 carbons, alkenyl having 2 to 12 carbons, or alkenyl having 2 to 12 carbons in which at least one hydrogen is replaced by fluorine. Preferred R¹ or R² is alkyl having 1 to 12 carbons for increasing the stability, or alkenyl having 2 to 12 carbons for decreasing the minimum temperature. Preferred R⁵ or R⁶ is alkenyl having 2 to 12 carbons for decreasing the viscosity, or alkyl having 1 to 12 carbons for increasing the stability. R³ and R⁴ are independently alkyl having 1 to 12 carbons, alkoxy having 1 to 12 carbons, alkenyl having 2 to 12 carbons or alkenyloxy having 2 to 12 carbons. Preferred R³ or R⁴ is alkyl having 1 to 12 carbons for increasing the stability, or alkoxy having 1 to 12 carbons for increasing the dielectric anisotropy.

Preferred alkyl is methyl, ethyl, propyl, butyl, pentyl, hexyl, heptyl or octyl. Further preferred alkyl is ethyl, propyl, butyl, pentyl or heptyl for decreasing the viscosity.

Preferred alkoxy is methoxy, ethoxy, propoxy, butoxy, pentyloxy, hexyloxy or heptyloxy. Further preferred alkoxy is methoxy or ethoxy for decreasing the viscosity.

Preferred alkenyl is vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl or 5-hexenyl. Further preferred alkenyl is vinyl, 1-propenyl, 3-butenyl or 3-pentenyl for decreasing the viscosity. The preferred configuration of —CH═CH— in the alkenyl depends on a position of a double bond. Trans is preferred in alkenyl such as 1-propenyl, 1-butenyl, 1-pentenyl, 1-hexenyl, 3-pentenyl and 3-hexenyl for decreasing the viscosity, for instance. C is preferred in alkenyl such as 2-butenyl, 2-pentenyl and 2-hexenyl.

Preferred examples of alkenyl in which at least one hydrogen is replaced by fluorine include 2,2-difluorovinyl, 3,3-difluoro-2-propenyl, 4,4-difluoro-3-butenyl, 5,5-difluoro-4-pentenyl and 6,6-difluoro-5-hexenyl. Further preferred examples include 2,2-difluorovinyl or 4,4-difluoro-3-butenyl for decreasing the viscosity.

The above alkyl is linear or branched, and does not include cyclic alkyl, wherein straight alkyl is preferred to branched alkyl. This applies in a similar manner to the cases of alkoxy, alkenyl, and alkenyl in which at least one hydrogen is replaced by fluorine. With regard to the configuration of 1,4-cyclohexylene, trans is preferred to cis for increasing the maximum temperature.

Ring A and ring B are independently 1,4-phenylene, 1,4-cyclohexylene, 1,4-cyclohexenylene, 1,3-dioxane-2,5-diyl, tetrahydropyran-2,5-diyl, or 1,4-phenylene in which at least one hydrogen is replaced by fluorine, chlorine or methyl. Preferred ring A or ring B is 1,4-cyclohexylene for decreasing the minimum temperature. Ring C is 1,4-cyclohexylene, tetrahydropyran-2,5-diyl, 1,4-phenylene, or 1,4-phenylene in which at least one hydrogen is replaced by fluorine or chlorine. When g is 3, ring C is 1,4-cyclohexylene or tetrahydropyran-2,5-diyl. Preferred ring C is 1,4-cyclohexylene for decreasing the viscosity, tetrahydropyran-2,5-diyl for increasing the dielectric anisotropy, or 1,4-phenylene for increasing the optical anisotropy. With regard to the configuration of 1,4-cyclohexylene, trans is preferred to cis for increasing the maximum temperature. Tetrahydropyran-2,5-diyl is represented by:

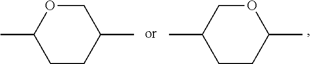

and is preferably

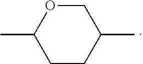

Ring D is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl or 7,8-difluorochroman-2,6-diyl. Preferred ring D is 2,3-difluoro-1,4-phenylene for decreasing the viscosity, 2-chloro-3-fluoro-1,4-phenylene for decreasing the optical anisotropy, or 7,8-difluorochroman-2,6-diyl for increasing the dielectric anisotropy. Ring E and ring F are independently 1,4-cyclohexylene, 1,4-phenylene or 2-fluoro-1,4-phenylene. Preferred ring E or ring F is 1,4-cyclohexylene for decreasing the viscosity or increasing the maximum temperature, or 1,4-phenylene for decreasing the minimum temperature.

X¹, X², X³ and X⁴ are independently fluorine, chlorine, or methyl. Preferred X¹, X², X³ or X⁴ is fluorine for decreasing the minimum temperature.

Z¹, Z², Z³, Z⁴, Z⁵, Z⁶, Z⁷ and Z⁸ are independently a single bond, —CH₂CH₂—, —CH₂O—, —OCH₂—, —COO— or —OCO—. Preferred Z¹, Z², Z³, Z⁴ or Z⁵ is a single bond for increasing the stability. Preferred Z⁶ is a single bond for decreasing the viscosity, —CH₂CH₂— for decreasing the minimum temperature, or —CH₂O— or —OCH₂— for increasing the dielectric anisotropy. Preferred Z⁷ or Z⁸ is a single bond for decreasing the viscosity, —CH₂CH₂— for decreasing the minimum temperature, or —COO— or —OCO— for increasing the maximum temperature.

Then, a, b, c and d are independently 0, 1, 2, 3 or 4. Preferred a, b, c or d is 1 or 2 for decreasing the minimum temperature, or 0 for increasing the maximum temperature. Then, e and f are independently 0 or 1. Preferred e or f is 0 for decreasing the minimum temperature, or 1 for increasing the voltage holding ratio. Further, g is 1, 2 or 3. Preferred g is 1 for decreasing the viscosity, or 2 or 3 for increasing the maximum temperature. Further, h is 0 or 1. Preferred h is 0 for decreasing the viscosity, or 1 for increasing the maximum temperature. Furthermore, j is 1 or 2. Preferred j is 1 for decreasing the viscosity, or 2 for increasing the maximum temperature.

In polymerizable compound (4), P¹ and P² are independently a polymerizable group selected from group (P-1), group (P-2) and group (P-3). The wavy line in group (P-1), group (P-2) or group (P-3) represents the site to form a bond.

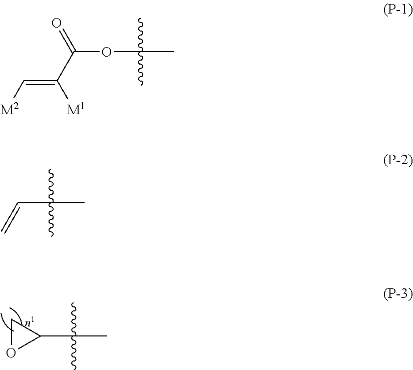

When both P¹ and P² are group (P-1), M¹ or (M²) of P¹, and M¹ of P² may be identical or different. In group (P-1), M¹ and M² are independently hydrogen, fluorine, methyl or trifluoromethyl. Preferred M¹ or M² is hydrogen or methyl for increasing the reactivity. Further preferred M¹ is methyl and further preferred M² is hydrogen. In group (P-3), n¹ is 1, 2, 3 or 4. Preferred n¹ is 1 or 2 for increasing the reactivity. Further preferred n¹ is 1.

When both P¹ and P² are group (P-2), at least one of Sp¹ and Sp² is alkylene in which at least of —CH₂— is replaced by —O—, —COO—, —OCO— or —OCOO—. More specifically, a case where both P¹ and P² are alkenyl such as 1-propenyl is excluded.

Preferred P¹ or P² is group (P-1) and group (P-2). Further preferred P¹ or P² is group (P-1). Preferred group (P-1) is —OCO—CH═CH₂ and —OCO—C(CH₃)═CH₂.

Sp¹ and Sp² are independently a single bond or alkylene having 1 to 12 carbons, and in the alkylene, at least one —CH₂— may be replaced by —O—, —S—, —NH—, —CO—, —COO—, —OCO— or —OCOO—, at least one —CH₂—CH₂— may be replaced by —CH═CH— or —C≡C—, and at least one hydrogen may be replaced by halogen or —C≡N. When hydrogen is replaced by —C≡N, the total number of carbons of alkylene substituted by cyano is preferably up to 12. Preferred Sp¹ or Sp² is a single bond.

Ring G and ring J are independently cyclohexyl, phenyl, 2-fluorophenyl, 3-fluorophenyl, 2,3-difluorophenyl, 2-methylphenyl, 3-methylphenyl, 2-(trifluoromethyl)phenyl, 3-(trifluoromethyl)phenyl or 2-naphthyl. Preferred ring G or ring J is phenyl. Ring I is 1,4-cyclohexylene, 1,4-phenylene, naphthalene-2,6-diyl, 2-fluoro-1,4-phenylene, 2,3-difluoro-1,4-phenylene, 2,5-difluoro-1,4-phenylene, 2-methyl-1,4-phenylene or 2-trifluoromethyl-1,4-phenylene. Preferred ring I is 1,4-phenylene, naphthalene-2,6-diyl, 2-fluoro-1,4-phenylene, 2,3-difluoro-1,4-phenylene or 2-methyl-1,4-phenylene. Particularly preferred ring I is 1,4-phenylene or 2-fluoro-1,4-phenylene.

Z⁹ is a single bond, —CH₂CH₂—, —CH₂O—, —OCH₂—, —COO—, —OCO—, —CO—CR⁷═CR⁸—, —CR⁸═CR⁷—CO—, —OCO—CR⁷═CR⁸—, —CR⁸═CR⁷—COO—, —CR⁷═CR⁸— or —C(═CR⁷R⁸)—; Z¹⁰ is a single bond, —CH₂CH₂—, —CH₂O—, —OCH₂—, —COO—, or —OCO—. Preferred Z⁹ or Z¹⁰ is a single bond, —CH₂CH₂—, —CH₂O—, —OCH₂—, —COO— or —OCO—. Further preferred Z⁹ or Z¹⁰ is a single bond.

R⁷ and R⁸ are independently hydrogen, halogen, alkyl having 1 to 10 carbons, or alkyl having 1 to 10 carbons in which at least one hydrogen is replaced by fluorine. Preferred R⁷ or R⁸ is hydrogen, fluorine, or alkyl having 1 to 3 carbons.

Then, m is 0, 1 or 2. Preferred m is 0. Then, k is 1, 2 or 3, n is 1, 2, or 3, and the sum of k and n is 4 or less. Preferred k or n is 1 or 2.

Fifth, preferred component compounds are shown. Preferred compounds (1) include above compounds (1-1) to (1-3). With respect to the compounds, it is preferred that at least one of the first components includes compound (1-2) or (1-3). It is preferred that at least two of the first components include a combination of compound (1-1) and compound (1-2), compound (1-1) and compound (1-3), or compound (1-2) and compound (1-3). Further preferred compounds (1) include above compounds (1-1-1) to (1-3-1). It is preferred that at least one of the first components includes compound (1-1-3), (1-1-4), (1-1-5), (1-1-6), (1-1-7), (1-2-1), (1-2-2) or (1-3-1). It is preferred that at least two of the first components include a combination of compound (1-2-1) and compound (1-2-2).

Preferred compounds (2) include above compounds (2-1) to (2-18). With respect to the compounds, it is preferred that at least one of the second components includes compound (2-1), (2-3), (2-4), (2-6), (2-8) or (2-12). It is preferred that at least two of the second components include a combination of compounds (2-1) and (2-6), compounds (2-1) and (2-12), compounds (2-3) and (2-6), compounds (2-3) and (2-12) or compounds (2-4) and (2-8).

Preferred compounds (3) include above compounds (3-1) to (3-13). With respect to the compounds, it is preferred that at least one of the third components includes compound (3-1), (3-3), (3-5), (3-6), (3-7) or (3-8). It is preferred that at least two of the third components include a combination of compounds (3-1) and (3-3), compounds (3-1) and (3-5) or compounds (3-1) and (3-6).

Preferred compounds (4) include above compounds (4-1) to (4-26). With respect to the compounds, it is preferred that at least one of the additive components includes compound (4-1), (4-2) or (4-18). It is preferred that at least two of the additive components include a combination of compounds (4-1) and (4-2), compounds (4-1) and (4-18) or compounds (4-2) and (4-18). In group (P-1), preferred M¹ or M² is hydrogen or methyl. Preferred Sp³ or Sp⁴ is a single bond, —CH₂CH₂—, —CH₂O—, —OCH₂—, —COO—, —OCO—, —CO—CH═CH— or —CH═CH—CO—.

Sixth, the additives that may be mixed with the composition are explained. Such additives include an optically active compound, an antioxidant, a UV light absorbent, a dye, an antifoaming agent, a polymerizable compound, a polymerization initiator and a polymerization inhibitor, etc. The optically active compound is mixed in the composition in order to induce a helical structure in liquid crystals to give a twist angle, and examples thereof include compounds (5-1) to (5-5). A preferred proportion of addition of the optically active compound is about 5 wt % or less based on the weight of the liquid crystal composition before addition. A further preferred proportion is in a range of about 0.01 wt % to about 2 wt %.

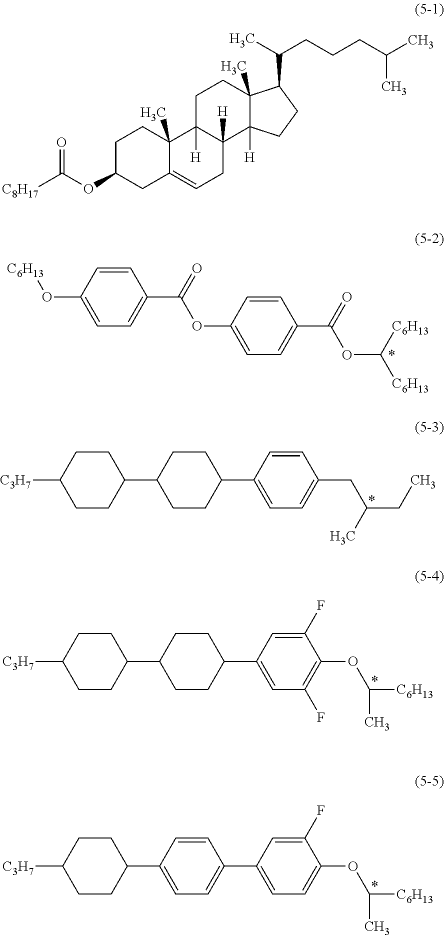

The antioxidant is mixed with the composition for preventing a decrease in the specific resistance caused by heating in air, or maintaining a large voltage holding ratio at room temperature and also at a temperature close to the maximum temperature of nematic phase after the device has been used for a long period of time.

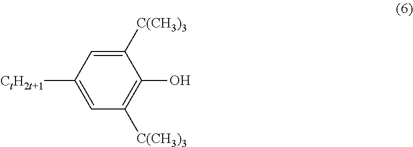

Preferred examples of the antioxidant include compound (6) where t is an integer from 1 to 9. In compound (6), preferred t is 1, 3, 5, 7 or 9, and further preferred t is 1 or 7. Compound (6) where t is 1 is effective in preventing a decrease in the specific resistance caused by heating in air because such compound (6) has a large volatility. Compound (6) where t is 7 is effective in maintaining a large voltage holding ratio at room temperature and also at a temperature close to the maximum temperature of nematic phase after the device has been used for a long period of time because such compound (6) has a small volatility. A preferred proportion of addition of the antioxidant is, based on the weight of the liquid crystal composition before addition, about 50 ppm or more for achieving the effect thereof, and about 600 ppm or less for avoiding a decrease in the maximum temperature or avoiding an increase in the minimum temperature. A further preferred ratio of addition is in the range of about 100 ppm to about 300 ppm.

Preferred examples of the ultraviolet light absorber include a benzophenone derivative, a benzoate derivative and a triazole derivative. A light stabilizer such as an amine having steric hindrance is also preferred. A preferred proportion of addition of the ultraviolet light absorber or the stabilizer is, based on the weight of the liquid crystal composition before addition, about 50 ppm or more for achieving the effect thereof, and about 10,000 ppm or less for avoiding a decrease in the maximum temperature or avoiding an increase in the minimum temperature. A further preferred proportion is in the range of about 100 ppm to about 10,000 ppm.

A dichroic dye such as an azo dye or an anthraquinone dye is added to the composition to adapt the same to a device having a guest host (GH) mode. A preferred proportion of addition of the dye is, based on the weight of the liquid crystal composition before addition, in the range of about 0.01 wt % to about 10 wt %. The antifoaming agent such as dimethyl silicone oil or methyl phenyl silicone oil is added to the composition for preventing foam formation. A preferred proportion of addition of the antifoaming agent is about 1 ppm or more for achieving the effect thereof, and about 1,000 ppm or less for avoiding a poor display. A further preferred proportion of addition is in the range of about 1 ppm to about 500 ppm.

The polymerizable compound is used to adapt the composition to a device having the polymer sustained alignment (PSA) mode. Compound (4) is suited to the purpose. Together with compound (4), a polymerizable compound different from compound (4) may be added to the composition. Preferred examples of such a polymerizable compound include a compound such as an acrylate, a methacrylate, a vinyl compound, a vinyloxy compound, a propenyl ether, an epoxy compound (oxirane, oxetane) and a vinyl ketone. Further preferred examples include an acrylate derivative and a methacrylate derivative. A preferred proportion of compound (4) is about 10 wt % or more based on the total weight of the polymerizable compound. A further preferred proportion is about 50 wt % or more. A still further preferred proportion is about 80 wt % or more. A particularly preferred proportion is as much as about 100 wt %.

The polymerizable compound such as compound (4) is polymerized by UV irradiation. The polymerizable compound may be polymerized in the presence of a suitable initiator such as a photopolymerization initiator. Suitable conditions for polymerization, suitable types of the initiator and suitable amounts thereof are known to those skilled in the art and are described in literatures. For example, Irgacure 651 (registered trade name; BASF), Irgacure 184 (registered trade name; BASF) or Darocure 1173 (registered trade name; BASF), each being a photoinitiator, is suitable for radical polymerization. A preferred proportion of the photopolymerization initiator is, based on the total weight of the polymerizable compound, in the range of about 0.1 wt % to about 5 wt %, and a further preferred proportion is in the range of about 1 wt % to about 3 wt %.

Upon storing the polymerizable compound such as compound (4), a polymerization inhibitor may be added for preventing polymerization. The polymerizable compound is ordinarily added to the composition without removing the polymerization inhibitor. Examples of the polymerization inhibitor include a hydroquinone derivative such as hydroquinone and methylhydroquinone, 4-tert-butylcatechol, 4-methoxyphenol and phenothiazine.

Seventh, the methods for synthesizing the component compounds are explained. The compounds can be prepared by known methods, of which the examples are shown below. Compound (2-1) is synthesized by the method described in JP 2000-053602 A. Compounds (3-1) and (3-5) are synthesized by the method described in JP S59-176221 A. Compound (4) is synthesized according to JP 2012-001526 A and WO 2010-131600 A. Compound (4-18) is synthesized by the method in JP H7-101900 A. The antioxidant is commercially available. A compound represented by formula (6) where t is 1 is available from Sigma-Aldrich Corporation. Compound (6) where t is 7 and so forth are prepared according to the method described in U.S. Pat. No. 3,660,505 B.

Any compounds whose synthetic methods are not described above can be prepared according to the methods described in books such as Organic Syntheses (John Wiley & Sons, Inc.), Organic Reactions (John Wiley & Sons, Inc.), Comprehensive Organic Synthesis (Pergamon Press) and New Experimental Chemistry Course (Shin Jikken Kagaku Koza in Japanese) (Maruzen Co., Ltd.). The composition is prepared according to publicly known methods using thus obtained compounds. For example, the component compounds are mixed and dissolved in each other by heating.

Last, the applications of the composition are explained. The composition mainly has a minimum temperature of about −10° C. or lower, a maximum temperature of about 70° C. or higher, and an optical anisotropy in the range of about 0.07 to about 0.20. The device including the composition has a large voltage holding ratio. The composition is suitable for use in an AM device. The composition is particularly suitable for use in a transmissive AM device. The composition can be used in the form of a composition having a nematic phase and an optically active composition by adding an optically active compound.

The composition can be used for the AM device. The composition can also be used for a PM device. The composition can also be used for an AM device and a PM device having a mode such as PC, TN, STN, ECB, OCB, IPS, FFS, VA or FPA. Use for the AM device having the IPS, FFS or VA mode is particularly preferred. The devices may be of a reflective type, a transmissive type or a transflective type. Use for the transmissive device is preferred. The composition can also be used for an amorphous silicon-TFT device or a polysilicon-TFT device. When the amount of addition of the polymerizable compound is increased, the composition can also be used for a polymer dispersed (PD) device in which a 3D network-polymer is formed in the composition.

One example of the method for manufacturing a device having a polymer sustained alignment type is as described below. A device having two substrates that are referred to as an array substrate and a color filter substrate is prepared. At least one of the substrates has an electrode layer thereon. Liquid crystal compounds are mixed to prepare a liquid crystal composition. A polymerizable compound is added to the composition. An additive may be further added when necessary. The composition is injected into the device. The device is irradiated with light, preferably with UV light, to polymerize the polymerizable compound, while a voltage is applied thereto. The composition containing the polymer is produced by the polymerization. The liquid crystal display device having a polymer sustained alignment mode is manufactured according to such a procedure.

In the procedure, upon the voltage application, liquid crystal molecules are aligned by an electric field. Molecules of the polymerizable compound are also aligned according to the alignment. The polymerizable compound polymerizes by ultraviolet light in the state, and therefore a polymer maintaining the alignment is produced. The response time of the device is shortened by the effect of the polymer. Image sticking is caused by poor operation of the liquid crystal molecules, and therefore the sticking is also to be simultaneously improved by the effect of the polymer. In addition, preliminary polymerization of the polymerizable compound in the composition would be also allowed to arrange the composition between the substrates of the liquid crystal display device.

### EXAMPLES

The invention will be explained in greater detail by way of Examples. The Examples are for illustrative purposes only and are not intended, nor should they be interpreted to, limit the scope of the invention. A synthesized compound was identified by methods such as an NMR analysis. Characteristics of a compound or a composition were measured by a method as described below.

NMR Analysis:

DRX-500 (made by Bruker BioSpin Corporation) was used for the measurement. In the measurement of ¹H-NMR, a sample was dissolved in a deuterated solvent such as CDCl₃, and measurement was carried out under the conditions of room temperature, 500 MHz and 16 times of accumulation. Tetramethylsilane was used as an internal standard. In the case of ¹⁹F-NMR, the measurement was carried out using CFCl₃ as an internal standard, and under a conditions of 24 times of accumulation. In the explanation of nuclear magnetic resonance spectra obtained, the symbols s, d, t, q, quin, sex, m and br stand for a singlet, a doublet, a triplet, a quartet, a quintet, a sextet, a multiplet and being broad, respectively.

Gas Chromatographic Analysis:

GC-14B Gas Chromatograph made by Shimadzu Corporation was used for the measurement. The carrier gas was helium (2 mL/min). The sample injector and the detector (FID) were set to 280° C. and 300° C., respectively. A capillary column DB-1 (length 30 m, bore 0.32 mm, film thickness 0.25 μm; dimethylpolysiloxane as a stationary phase, non-polar) made by Agilent Technologies, Inc. was used for separation of the component compounds. After the column was kept at 200° C. for 2 min, the column was heated to 280° C. at a rate of 5° C./rain. A sample was prepared in an acetone solution (0.1 wt %), and 1 μL of the solution was injected in the sample injector. A recorder was C-R5A Chromatopac made by Shimadzu Corporation or an equivalent thereof. The resulting chromatogram showed a retention time of a peak and a peak area corresponding to each of the component compounds.

As a solvent for diluting the sample, chloroform, hexane and so forth may also be used. The following capillary columns may also be used for separating the component compounds: HP-1 (length 30 m, bore 0.32 mm, film thickness 0.25 μm) made by Agilent Technologies, Inc., Rtx-1 (length 30 m, bore 0.32 mm, film thickness 0.25 μm) made by Restek Corporation and BP-1 (length 30 m, bore 0.32 mm, film thickness 0.25 μm) made by SGE International Pty. Ltd. A capillary column CBP1-M50-025 (length 50 m, bore 0.25 mm, film thickness 0.25 μm) made by Shimadzu Corporation may also be used for the purpose of avoiding an overlap of peaks of the compounds.

The ratio of the liquid crystal compounds contained in the composition may be calculated by the method as described below. A mixture of liquid crystal compounds was detected by means of a gas chromatograph (FID). The ratio of peak areas in the gas chromatogram corresponds to the ratio (weight ratio) of the liquid crystal compounds. When the above capillary columns were used, the correction coefficient of each of the liquid crystal compounds may be regarded as 1 (one). Accordingly, the proportions (wt %) of the liquid crystal compounds was calculated from the ratio of peak areas.

Sample for measurement: Upon measuring characteristics of a composition, the composition was used as a sample as was. Upon measuring characteristics of a compound, a sample for measurement was prepared by mixing the compound (15 wt %) with a base liquid crystal (85 wt %). The values of characteristics of the compound were calculated using the values obtained by the measurement, according to an extrapolation method: (extrapolated value)−{(measured value of a sample for measurement)−0.85×(measured value of base liquid crystal)}/0.15. When a smectic phase (or crystals) precipitated at the ratio thereof at 25° C., the ratio of the compound to the base liquid crystal was changed step by step in the order of (10 wt %:90 wt %), (5 wt %:95 wt %) and (1 wt %:99 wt %). The values of maximum temperature, optical anisotropy, viscosity and dielectric anisotropy with regard to the compound were obtained according to the extrapolation method.

The base liquid crystal described below was used. The proportion of each component was expressed in terms of wt %.

| | |
|---|---|
| 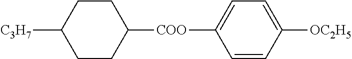 | 17.2% |
| 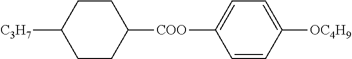 | 27.6% |
| 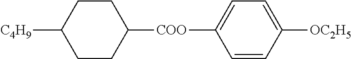 | 20.7% |
| 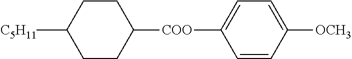 | 20.7% |
| 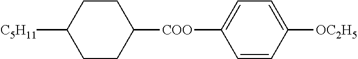 | 13.8% |

Measuring Method:

Characteristics were measured according to the methods described below. Most of the methods are applied as described in Standard of Japan Electronics and Information Technology Industries Association (hereinafter, abbreviated to JEITA), JEITA ED-2521B, which was discussed and established by JEITA, or as modified thereon. No thin film transistor (TFT) was attached to the TN device used for the measurement.

(1) Maximum Temperature of Nematic Phase (NI; ° C.):

A sample was placed on a hot plate in a melting point apparatus equipped with a polarizing microscope and was heated at a rate of 1° C./min. The temperature when a part of the sample began to change from a nematic phase to an isotropic liquid was measured. The maximum temperature of nematic phase may be occasionally abbreviated as “maximum temperature.”

(2) Minimum Temperature of Nematic Phase (T_{c}; ° C.):

Samples each having a nematic phase were put in glass vials and kept in freezers at temperatures of 0° C., −10° C., −20° C., −30° C. and −40° C. for 10 days, and then liquid crystal phases were observed. For example, when a sample maintained the nematic phase at −20° C. and changed to crystals or a smectic phase at −30° C., T_{c} was expressed as “T_{c}<−20° C.” The minimum temperature of nematic phase may be occasionally abbreviated as “minimum temperature.”

(3) Viscosity (Bulk Viscosity; η; Measured at 20° C.; mPa·s):

A cone-plate (E type) rotational viscometer made by Tokyo Keiki Co., Ltd. was used for the measurement.

(4) Viscosity (Rotational Viscosity; γ1; Measured at 25° C.; mPa·s);

The measurement was carried out according to the method described in M. Imai et al., Molecular Crystals and Liquid Crystals, Vol. 259, p. 37 (1995). The sample was put in a VA device in which a distance (cell gap) between two glass substrates was 20 μm. A Voltage was stepwise applied to the device in the range of 39 V to 50 V at an increment of 1 V. After a period of 0.2 second with no application, voltage was repeatedly applied under conditions of only one of rectangular waves (rectangular pulse; 0.2 second) and no application (2 seconds). The peak current and the peak time of a transient current generated by the application were measured. The value of rotational viscosity was obtained from the measured values and calculation equation (8) on page 40 of the paper presented by M. Imai et al. The dielectric anisotropy required for the calculation was measured according to the procedures described in section (6).

(5) Optical Anisotropy (Refractive Index Anisotropy; Δn; measured at 25° C.):

The measurement was carried out by means of an Abbe refractometer with a polarizing plate mounted on an ocular, using light at a wavelength of 589 nm. The surface of a main prism was rubbed in one direction, and then a sample was added dropwise onto the main prism. The refractive index n_{//} was measured when the direction of polarized light was parallel to the direction of rubbing. The refractive index n_{⊥} was measured when the direction of polarized light was perpendicular to the direction of rubbing. The value of optical anisotropy was calculated from the equation “Δn=n_{//}−n_{⊥}.”

(6) Dielectric Anisotropy (Δ∈; Measured at 25° C.):

The value of Δ∈ was calculated from the equation “Δ∈=∈_{//}−∈_{⊥}.” The dielectric constants ∈_{//} and ∈_{⊥} were measured as described below.

(1) Measurement of ∈_{//}: An ethanol (20 mL) solution of octadecyltriethoxysilane (0.16 mL) was applied to a well-cleaned glass substrate. The glass substrate was rotated with a spinner, and then heated at 150° C. for 1 hour. A sample was put in a VA device in which the distance (cell gap) between two glass substrates was 4 μm, and the device was sealed with an ultraviolet-curable adhesive. Sine waves (0.5 V, 1 kHz) were applied to the device, and after 2 seconds, the dielectric constant ∈_{//} in the major axis direction of liquid crystal molecules was measured.
(2) Measurement of ∈_{⊥}: A polyimide solution was applied to a well-cleaned glass substrate. The glass substrate was calcined, and then rubbing treatment was applied to an alignment film obtained. A sample was put in a TN device in which the distance (cell gap) between two glass substrates is 9 μm, and the twist angle was 80 degrees. Sine waves (0.5 V, 1 kHz) were applied to the device, and after 2 seconds, the dielectric constant ∈_{⊥} in the minor axis direction of the liquid crystal molecules was measured.

(7) Threshold Voltage (Vth; Measured at 25° C.; V):

An LCD-5100 luminance meter made by Otsuka Electronics Co., Ltd. was used for the measurement. The light source was a halogen lamp. A sample was put in a normally black mode VA device in which the distance (cell gap) between two glass substrates was 4 μm and the rubbing direction was antiparallel, and the device was sealed by an UV-curable adhesive. The voltage (32 Hz, rectangular waves) being applied to the device was increased stepwise from 0 V to 20 V at an increment of 0.02 V. On the occasion, the device was irradiated with light from a direction perpendicular thereto, and the amount of light transmitted through the device was measured. A voltage-transmittance curve was prepared, in which the maximum amount of light corresponds to 100% transmittance and the minimum amount of light corresponds to 0% transmittance. The threshold voltage is the voltage at 10% transmittance.

(8) Voltage Holding Ratio (VHR-1a; Measured at 25° C.; %):

A TN device used for measurement had a polyimide alignment film, and the distance (cell gap) between two glass substrates was 5 μm. A sample was put in the device, and then the device was sealed with an UV-curable adhesive. A pulse voltage (60 microseconds at 5 V) was applied to the device to charge the device. The decaying voltage was measured for 16.7 milliseconds with a high-speed voltmeter, and area A between a voltage curve and a horizontal axis in a unit cycle was determined. Area B is an area without decay. The voltage holding ratio is expressed in terms of the percentage of area A to area B.

(9) Voltage Holding Ratio (VHR-2a; Measured at 60° C.; %):

The voltage holding ratio was measured in a manner similar to the procedures described above except that the measurement was carried out at 60° C. instead of 25° C. The value obtained value was expressed in terms of VHR-2a. In a composition containing a polymerizable compound, while a voltage of 15 V was applied to a TN device, the TN device was irradiated with UV light of 25 mW/cm² for 400 seconds to polymerize the polymerizable compound. For irradiation with ultraviolet light, an EXECURE4000-D type mercury-xenon lamp made by HOYA CANDEO OPTRONICS CORPORATION was used.

(10) Voltage Holding Ratio (VHR-3a; Measured at 60° C.; %):

After irradiation with ultraviolet light was performed, a voltage holding ratio was measured, and the stability to UV light was evaluated. A TN device used for measurement had a polyimide alignment film, and a cell gap was 5 μm. A sample was injected into the device, and the device was irradiated with light for 167 min. The light source was black light (peak wavelength of 369 nm), and the distance between the device and the light source was 5 mm. In the measurement of VHR-3a, the decaying voltage was measured for 166.7 milliseconds. In a composition containing a polymerizable compound, the polymerizable compound was polymerized under conditions described in section (9). A composition having a large VHR-3a has a large stability to UV light.

(11) Voltage Holding Ratio (VHR-4-a; Measured at 25° C.; %):

A TN device into which a sample was injected was heated in a constant-temperature bath at 80° C. for 500 hours, and then the stability to heat was evaluated by measuring a voltage holding ratio. In measuring VHR-4a, the decaying voltage was measured for 116.7 milliseconds. A composition having a large VHR-4a has a large stability to heat.

(12) Response Time (τ; Measured at 25° C.; ms):

An LCD-5100 luminance meter made by Otsuka Electronics Co., Ltd. was used for the measurement, wherein the light source was a halogen lamp and the low-pass filter was set at 5 kHz.

(1) Composition containing no polymerizable compound: A sample was put in a normally black mode device in which the distance (cell gap) between two glass substrates was 4 μm and the rubbing direction was antiparallel. The device was sealed with an ultraviolet-curable adhesive. Rectangular waves (60 Hz, 10 V, 0.5 second) were applied to the device. On the occasion, the device was irradiated with light from a direction perpendicular to the device, and the amount of light transmitted through the device was measured. The maximum amount of light was regarded to be 100% transmittance, and the minimum amount of light was regarded to be 0% transmittance. The response time was expressed in terms of the period of time required for a change from 90% transmittance to 10% transmittance (fall time; millisecond).

(2) Composition containing a polymerizable compound: A sample was put in a normally black mode PVA device in which the distance (cell gap) between two glass substrates was 3.2 μm, and the rubbing direction was antiparallel. The device was sealed using an UV-curable adhesive. The device was irradiated with UV light of 25 mW/cm² for 400 seconds, while a voltage of 15 V was applied to the device. For irradiation with ultraviolet light, an EXECURE4000-D type mercury-xenon lamp made from HOYA CANDEO OPTRONICS CORPORATION was used. Rectangular waves (60 Hz, 10 V, 0.5 second) were applied to the device. On the occasion, the device was irradiated with light from a direction perpendicular to the device, and the amount of light transmitted through the device was measured. The maximum amount of light was regarded to be 100% transmittance, and the minimum amount of light was regarded to be 0% transmittance. The response time was expressed in terms of the period of time required for a change from 10% transmittance to 90% transmittance (rise time; millisecond).

(13) Specific Resistance (ρ; Measured at 25° C.; Ωcm):

Into a vessel equipped with electrodes, 1.0 milliliter of a sample was injected. A DC voltage (10 V) was applied to the vessel, and a DC current after 10 seconds was measured. The specific resistance was calculated from the following equation: (specific resistance)={(voltage)×(electric capacity of a vessel)}/{(direct current)×(dielectric constant of vacuum)}.

The compounds in Comparative Examples and Examples were described using symbols according to definitions in Table 3 below. In Table 3, the configuration of 1,4-cyclohexylene is trans. A parenthesized number next to a symbolized compound corresponds to the number of the compound. The symbol (−) means any other liquid crystal compound. The proportion (percentage) of a liquid crystal compounds is expressed in terms of weight percent (wt %) based on the total weight of the liquid crystal composition.

TABLE 3
Method for Description of Compounds using Symbols
R—(A₁)—Z₁— . . . —Zₙ—(Aₙ)—R′

| 1) Left-terminal Group R | Symbol |
|---|---|
| CₙH₂ₙ₊₁— | n- |
| CₙH₂ₙ₊₁O— | nO— |
| CₘH₂ₘ₊₁OCₙH₂ₙ— | mOn— |
| CH₂═CH— | V— |
| CₙH₂ₙ₊₁—CH═CH— | nV— |
| CH₂═CH—CₙH₂ₙ— | Vn— |
| CₘH₂ₘ₊₁—CH═CH—CₙH₂ₙ— | mVn— |
| CF₂═CH— | VFF— |
| CF₂═CH—CₙH₂ₙ— | VFFn— |
| CH₂═CH—COO— | AC— |
| CH₂═C(CH₃)—COO— | MAC— |
| 2) Right-terminal Group | Symbol |
| —CₙH₂ₙ₊₁ | -n |
| —OCₙH₂ₙ₊₁ | —On |
| —CH═CH₂ | —V |
| —CH═CH—CₙH₂ₙ₊₁ | —Vn |
| —CₙH₂ₙ—CH═CH₂ | —nV |
| —CₘH₂ₘ—CH═CH—CₙH₂ₙ₊₁ | —mVn |
| —CH═CF₂ | —VFF |
| —OCO—CH═CH₂ | —AC |
| —OCO—C(CH₃)═CH₂ | —MAC |
| 3) Bonding Group —Zₙ— | Symbol |
| —CₙH₂ₙ— | n |
| —COO— | E |
| —CH═CH— | V |
| —CH═CHO— | VO |
| —OCH═CH— | OV |
| —CH₂O— | 1O |
| —OCH₂— | O1 |
| 4) Ring Structure —Aₙ— | Symbol |
| 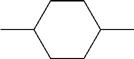 | H |
| 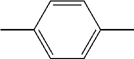 | B |
| 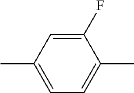 | B(F) |
| 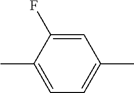 | B(2F) |
| 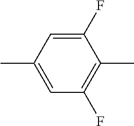 | B(F,F) |
| 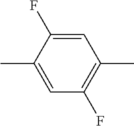 | B(2F,5F) |
| 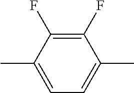 | B(2F,3F) |
| 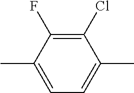 | B(2F,3CL) |
| 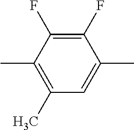 | B(2F,3F,6Me) |
| 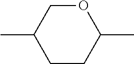 | dh |
| 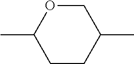 | Dh |
| 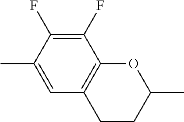 | Cro(7F,8F) |

5) Examples of Description
Example 1 2-BBB(F)B-5

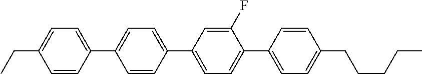 [SMILES: CCCCCc1ccc(-c2ccc(-c3ccc(-c4ccc(CC)cc4)cc3)cc2F)cc1]

Example 2 MAC—BB—MAC

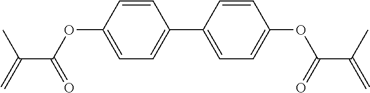 [SMILES: C=C(C)C(=O)Oc1ccc(-c2ccc(OC(=O)C(=C)C)cc2)cc1]

Example 3 V—HHB-1

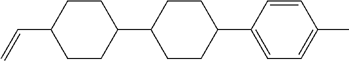 [SMILES: C=CC1CCC(C2CCC(c3ccc(C)cc3)CC2)CC1]

Example 4 3-DhHB(2F,3F)—O2

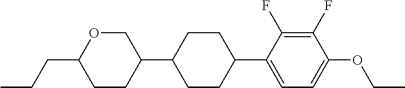 [SMILES: CCCC1CCC(C2CCC(c3ccc(OCC)c(F)c3F)CC2)CO1]

### Example 1

### Synthesis of Compound (1-2-1)

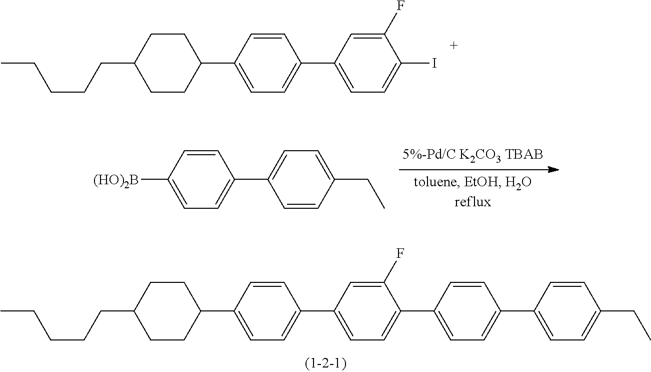 [SMILES: CCCCCC1CCC(c2ccc(-c3ccc(I)c(F)c3)cc2)CC1 ; CCc1ccc(-c2ccc(B(O)O)cc2)cc1 ; CCCCCC1CCC(c2ccc(-c3ccc(-c4ccc(-c5ccc(CC)cc5)cc4)c(F)c3)cc2)CC1]

3-Fluoro-4-iodo-4′-(4-pentylcyclohexyl)-1,1′-biphenyl (22.08 g, 49.03 mmol), (4′-ethyl-[1,1′-biphenyl]-4-yl)boronic acid (11.64 g, 51.49 mmol), 5%-palladium on carbon (50 wt % H₂O, 0.66 g), potassium carbonate (10.17 g, 73.55 mmol) and tetrabutylammonium bromide (TBAB) (3.95 g, 12.26 mmol) were refluxed for 3 hours in a mixed solvent of toluene (300 mL), ethanol (50 mL) and water (100 mL). The reaction mixture was filtered, and the filtrate was concentrated. A precipitated solid was obtained by filtration, and washed with water. The solid was purified by silica gel chromatography (effluent: THF), and further recrystallization from toluene to give compound (1-2-1) (17.38 g; yield 69.5%).

¹H-NMR (δ ppm; CDCl₃): 7.70-7.65 (m, 4H), 7.60-7.52 (m, 5H), 7.47-7.44 (m, 1H), 7.42-7.38 (m, 1H), 7.33-7.29 (m, 4H), 2.71 (q, 2H), 2.53 (tt, 1H), 1.97-1.87 (m, 4H), 1.55-1.45 (m, 2H), 1.38-1.20 (m, 12H), 1.13-1.03 (m, 2H), 0.91 (t, 3H).

Characteristics of compound (1-2-1) were as described below: maximum temperature (NI)=273.7° C.; dielectric anisotropy (As)=7.9; optical anisotropy (Δn)=0.337; viscosity (η)=75.5 mPa·s.

A composition was prepared from 5 wt % of compound (1-2-1), and 95 wt % a base liquid crystal. Characteristics of the composition were measured and the values of the characteristics were calculated by extrapolating the measured values.

NI=332.6° C.; Δ∈=−1.3; Δn=0.361; η=57.2 mPa·s.

### Example 2

### Synthesis of Compound (1-2-2)

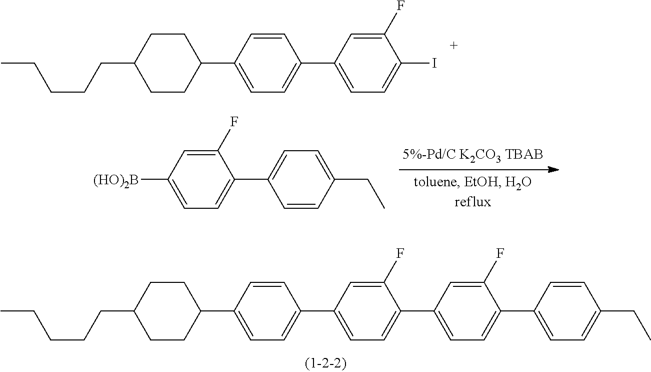

3-Fluoro-4-iodo-4′-(4-pentylcyclohexyl)-1,1′-biphenyl (10.0 g, 22.20 mmol), (4′-ethyl-2-fluoro-[1,1′-biphenyl]-4-yl)boronic acid (6.50 g, 26.64 mmol), 5%-palladium on carbon (50 wt % H₂O, 0.50 g), potassium carbonate (6.14 g, 44.41 mmol) and tetrabutylammonium bromide (TBAB) (1.79 g, 5.55 mmol) were refluxed for 3 hours in a mixed solvent of toluene (50 mL), ethanol (50 mL) and water (20 mL). The reaction mixture was filtered, and the filtrate was concentrated. A precipitated solid was obtained by filtration, and washed with water. The solid was purified by silica gel chromatography (effluent: THF), and further recrystallization from a toluene-Solmix (2:1 in a volume ratio) to give compound (1-2-2) (5.22 g; yield 44.8%).

¹H-NMR (δ ppm; CDCl₃): 7.58-7.50 (m, 6H), 7.48-7.38 (m, 4H), 7.34-7.28 (m, 4H), 2.72 (q, 2H), 2.52 (tt, 1H), 1.98-1.86 (m, 4H), 1.56-1.45 (m, 2H), 1.38-1.20 (m, 12H), 1.13-1.02 (m, 2H), 0.91 (t, 3H).

A composition was prepared from 5 wt % of compound (1-2-2), and 95 wt % a base liquid crystal. Characteristics of the composition were measured and the values of the characteristics were calculated by extrapolating the measured values.

NI=304.6° C.; Δ∈=−1.3; Δn=0.335; η=47.0 mPa·s.

### Example 3

### Synthesis of Compound (1-3-1)

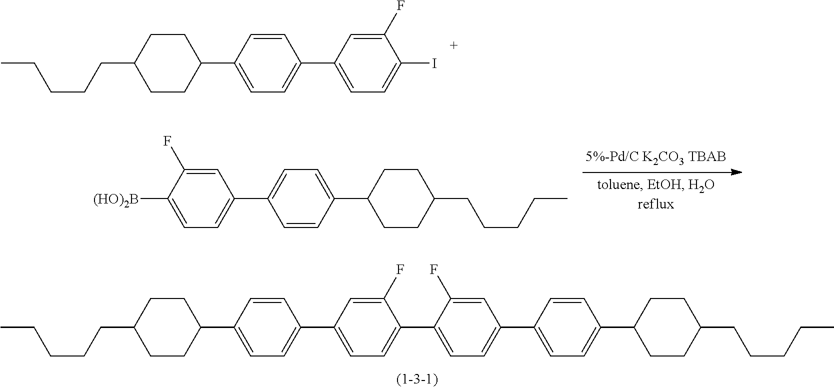

3-Fluoro-4-iodo-4′-(4-pentylcyclohexyl)-1,1′-biphenyl (21.0 g, 46.63 mmol), (3-fluoro-4′-(4-pentylcyclohexyl)-[1,1′-biphenyl]-4-yl)boronic acid (20.6 g, 55.95 mmol), 5%-palladium on carbon (50 wt % H₂O, 1.05 g), potassium carbonate (12.9 g, 93.34 mmol) and tetrabutylammonium bromide (TBAB) (3.76 g, 11.7 mmol) were refluxed for 3 hours in a mixed solvent of toluene (300 mL), ethanol (50 mL) and water (100 mL). The reaction mixture was filtered, and the filtrate was concentrated. A precipitated solid was obtained by filtration, and washed with water. The solid was purified by silica gel chromatography (effluent: THF), and further recrystallization from toluene to give compound (1-3-1) (22.51 g; yield 74.6%).

¹H-NMR (δ ppm; CDCl₃): 7.58-7.54 (m, 4H), 7.51-7.44 (m, 4H), 7.43-7.38 (m, 2H), 7.34-7.29 (m, 4H), 2.53 (tt, 2H), 1.98-1.86 (m, 8H), 1.57-1.45 (m, 4H), 1.38-1.20 (m, 18H), 1.13-1.02 (m, 4H), 0.91 (t, 6H).

A composition was prepared from 3 wt % of compound (1-3-1), and 97 wt % a base liquid crystal. Characteristics of the composition were measured and the values of the characteristics were calculated by extrapolating the measured values.

NI=357.9° C.; Δ∈=−1.3; Δn=0.314; η=89.4 mPa·s.

### Example M1

| | | |
|---|---|---|
| V2-BB(F)B(F)B-3 | (1-1-2) | 0.5% |
| 3-H1OB(2F,3F)-O2 | (2-3) | 4.0% |
| V2-BB(2F,3F)-O1 | (2-4) | 5.0% |
| V2-BB(2F,3F)-O2 | (2-4) | 9.0% |
| 1V2-BB(2F,3F)-O2 | (2-4) | 6.0% |
| V-HHB(2F,3F)-O1 | (2-6) | 3.0% |
| V-HHB(2F,3F)-O2 | (2-6) | 10.0% |
| 3-HH1OB(2F,3F)-O2 | (2-8) | 11.0% |
| 3-HH-V | (3-1) | 27.0% |
| 3-HH-V1 | (3-1) | 9.0% |
| 3-HHB-O1 | (3-5) | 3.0% |
| V-HHB-1 | (3-5) | 3.5% |
| 2-BB(2F,3F)B-3 | (—) | 9.0% |

The composition having a negative dielectric anisotropy described above was prepared and its characteristics were measured.

NI=76.0° C.; Tc<−20° C.; Δn=0.112; Δ∈=−3.1; Vth=2.31 V; τ=3.9 ms.

To the composition, a compound being compound (4-2) below was added in a proportion of 0.3 wt %.

| | |
|---|---|
| MAC-VO-BB-MAC | (4-2) |

The composition after addition was irradiated with UV light, and then its voltage holding ratios VHR-2a and VHR-3a were measured.

VHR-2a=95.5%; VHR-3a=53.6%.

### Comparative Example M1

A composition containing no compound (1-1-2) was prepared. In the composition in Example M1, twelve compounds from which compound (1-1-2) was excluded were mixed at an identical ratio. Characteristics of the composition were measured.

NI=74.9° C.; Tc<−20° C.; Δn=0.110; Δ∈=−3.1; Vth=2.29 V; τ=4.0 ms.

To the composition, a compound being compound (4-2) below was added in a proportion of 0.3 wt %.

| | |
|---|---|
| MAC-VO-BB-MAC | (4-2) |

The composition after addition was irradiated with UV light, and then its voltage holding ratios VHR-2a and VHR-3a were measured.

VHR-2a=91.3%; VHR-3a=34.1%.

The voltage holding ratio (VHR-2a) of the composition in Example M1 was 95.5%, and the voltage holding ratio of the composition in Comparative Example M1 was 91.3%. The voltage holding ratio (VHR-3a) of the composition in Example M1 was 53.6%, and the voltage holding ratio of the composition in Comparative Example M1 was 34.1%. The results present that the TN device in Example M1 was found to have a larger voltage holding ratio than the ratio in Comparative Example M1. Therefore, the composition according to the invention can be concluded to be superb from a viewpoint of a liquid crystal display device having a polymer sustained alignment mode.

### Example M2

| | | |
|---|---|---|
| 5-BB(F)BB(2F)-2 | (1-1-3) | 1.0% |
| 3-H1OB(2F,3F)-O2 | (2-3) | 8.0% |
| V2-BB(2F,3F)-O1 | (2-4) | 5.0% |
| V2-BB(2F,3F)-O2 | (2-4) | 9.0% |
| 1V2-BB(2F,3F)-O4 | (2-4) | 6.0% |
| V-HHB(2F,3F)-O2 | (2-6) | 10.0% |
| V-HHB(2F,3F)-O4 | (2-6) | 3.0% |
| 1V2-HHB(2F,3F)-O2 | (2-6) | 4.0% |
| 3-HH1OB(2F,3F)-O2 | (2-8) | 11.0% |
| 3-HH-V | (3-1) | 26.0% |
| 1-HH-2V1 | (3-1) | 5.0% |
| 5-HB-O2 | (3-2) | 3.0% |
| 3-HHB-O1 | (3-5) | 5.0% |
| V-HHB-1 | (3-5) | 4.0% |

The composition having a negative dielectric anisotropy described above was prepared and its characteristics were measured.

NI=75.6° C.; Tc<−20° C.; Δn=0.101; Δ∈=−3.4; Vth=2.19 V.

To the composition, a compound being compound (4-2) below was added in a proportion of 0.3 wt %.

| | |
|---|---|
| MAC-VO-BB-MAC | (4-2) |

The composition after addition was irradiated with UV light, and then its voltage holding ratios VHR-2a and VHR-3a were measured.

VHR-2a=95.9%; VHR-3a=55.7%.

### Example M3

| | | |
|---|---|---|
| 5-BB(F)B(F)B(F)-3 | (1-1-7) | 1.2% |
| 5-HBB(F)B(2F)BH-5 | (1-3-1) | 0.3% |
| 3-BB(2F,3F)-O2 | (2-4) | 9.0% |
| 2O-BB(2F,3F)-O2 | (2-4) | 3.0% |
| 2-HH1OB(2F,3F)-O2 | (2-8) | 10.0% |
| 3-HH1OB(2F,3F)-O2 | (2-8) | 20.0% |
| 2-HH-3 | (3-1) | 19.0% |
| 3-HH-4 | (3-1) | 4.0% |
| 3-HH-V | (3-1) | 8.0% |
| V2-BB-1 | (3-3) | 3.0% |
| 1-BB-3 | (3-3) | 7.5% |
| V-HHB-3 | (3-5) | 5.0% |
| 3-HBB-2 | (3-6) | 4.0% |
| 5-B(F)BB-2 | (3-7) | 3.0% |
| 5-HBBH-3 | (3-11) | 3.0% |

The composition having a negative dielectric anisotropy described above was prepared and its characteristics were measured.

NI=83.2° C.; Tc<−20° C.; Δn=0.107; Δ∈=−2.6; Vth=2.41 V.

To the composition, a compound being compound (4-1) below was added in a proportion of 0.2 wt %, and a compound being compound (4-2) below was added in a proportion of 0.2 wt %.

| | |
|---|---|
| MAC-B(2F)B-MAC | (4-1) |
| AC-VO-BB-OV-AC | (4-2) |

The composition after addition was irradiated with UV light, and then its voltage holding ratios VHR-2a and VHR-3a were measured.

VHR-2a=96.1%; VHR-3a=58.2%.

### Example M4

| | | |
|---|---|---|
| 2-BBB(F)B-5 | (1-1-1) | 0.3% |
| V2-BB(F)BB(2F)-3 | (1-1-3) | 0.3% |
| 3-BB(2F,3F)-O2 | (2-4) | 10.0% |
| 5-BB(2F,3F)-O4 | (2-4) | 3.0% |
| 2-HH1OB(2F,3F)-O2 | (2-8) | 10.0% |
| 3-HH1OB(2F,3F)-O2 | (2-8) | 21.4% |
| 2-HH-3 | (3-1) | 21.0% |
| 3-HH-V | (3-1) | 8.0% |
| 1-BB-3 | (3-3) | 8.0% |
| 1V2-BB-1 | (3-3) | 3.0% |
| V2-HHB-1 | (3-5) | 5.0% |
| 3-HBB-2 | (3-6) | 4.0% |
| 5-B(F)BB-3 | (3-7) | 3.0% |
| 1O1-HBBH-4 | (—) | 3.0% |

The composition having a negative dielectric anisotropy described above was prepared and its characteristics were measured.

NI=79.1° C.; Tc<−20° C.; Δn=0.107; Δ∈=−2.5; Vth=2.44 V.

To the composition, a compound being compound (4-2) below was added in a proportion of 0.3 wt %.

| | |
|---|---|
| AC-VO-BB-MAC | (4-2) |

The composition after addition was irradiated with UV light, and then its voltage holding ratios VHR-2a and VHR-3a were measured.

VHR-2a=96.3%; VHR-3a=56.8%.

### Example M5

| | | |
|---|---|---|
| 5-BB(F)B(F)B-2 | (1-1-2) | 0.3% |
| 5-HBB(F)BB-2 | (1-2-1) | 0.3% |
| V2-BB(2F,3F)-O2 | (2-4) | 12.0% |
| 1V2-BB(2F,3F)-O2 | (2-4) | 6.0% |
| 1V2-BB(2F,3F)-O4 | (2-4) | 3.0% |
| V-HHB(2F,3F)-O1 | (2-6) | 6.0% |
| V-HHB(2F,3F)-O2 | (2-6) | 12.0% |
| V-HHB(2F,3F)-O4 | (2-6) | 5.0% |
| 3-HDhB(2F,3F)-O2 | (2-10) | 5.0% |
| 3-dhBB(2F,3F)-O2 | (2-13) | 4.4% |
| 3-HH-V | (3-1) | 29.0% |
| 1-BB-3 | (3-3) | 6.0% |
| V-HHB-1 | (3-5) | 5.0% |
| 1-BB(F)B-2V | (3-8) | 3.0% |
| 3-HHEBH-4 | (3-9) | 3.0% |

The composition having a negative dielectric anisotropy described above was prepared and its characteristics were measured.

NI=79.0° C.; Tc<−20° C.; Δn=0.114; Δ∈=−2.9; Vth=2.33 V.

To the composition, a compound being compound (4-18) below was added in a proportion of 0.3 wt %.

| | |
|---|---|
| MAC-BB(F)B-OV-MAC | (4-18) |

The composition after addition was irradiated with UV light, and then its voltage holding ratios VHR-2a and VHR-3a were measured.

VHR-2a=97.7%; VHR-3a=65.4%.

### Example M6

| | | |
|---|---|---|
| 4-B(F)B(F)B(F)B(F)-2 | (1-1-8) | 0.3% |
| V2-BB(2F,3F)-O2 | (2-4) | 12.0% |
| 1V2-BB(2F,3F)-O2 | (2-4) | 6.0% |
| 1V2-BB(2F,3F)-O4 | (2-4) | 3.0% |
| V-HHB(2F,3F)-O1 | (2-6) | 6.0% |
| V-HHB(2F,3F)-O2 | (2-6) | 7.0% |
| V-HHB(2F,3F)-O4 | (2-6) | 5.0% |
| 1V2-HHB(2F,3F)-O4 | (2-6) | 5.0% |
| 3-HDhB(2F,3F)-O2 | (2-10) | 5.0% |
| 3-dhBB(2F,3F)-O2 | (2-13) | 5.0% |
| 3-HH-V | (3-1) | 28.7% |
| V2-HB-1 | (3-2) | 6.0% |
| V-HHB-1 | (3-5) | 5.0% |
| 2-BB(F)B-5 | (3-8) | 3.0% |
| 5-HBB(F)B-3 | (3-13) | 3.0% |

The composition having a negative dielectric anisotropy described above was prepared and its characteristics were measured.

NI=79.3° C.; Tc<−20° C.; Δn=0.113; Δ∈=−2.9; Vth=2.36 V.

To the composition, a compound being compound (4-2) below was added in a proportion of 0.3 wt %, and a compound being compound (4-18) below was added in a proportion of 0.1 wt %.

| | |
|---|---|
| MAC-VO-BB-OV-MAC | (4-2) |
| MAC-BB(F)B-AC | (4-18) |

The composition after addition was irradiated with UV light, and then its voltage holding ratios VHR-2a and VHR-3a were measured.

VHR-2a=97.6%; VHR-3a=63.7%.

### Example M7

| | | |
|---|---|---|
| 5-BB(F)B(F)B-2 | (1-1-2) | 0.3% |
| 3-HB(2F,3F)-O2 | (2-1) | 3.0% |
| V2-BB(2F,3F)-O2 | (2-4) | 11.7% |
| 1V2-BB(2F,3F)-O2 | (2-4) | 6.0% |
| V2-HHB(2F,3F)-O2 | (2-6) | 5.0% |
| 3-HDhB(2F,3F)-O2 | (2-10) | 5.0% |
| 3-HBB(2F,3F)-O2 | (2-12) | 3.0% |
| V-HBB(2F,3F)-O2 | (2-12) | 6.0% |
| V2-HBB(2F,3F)-O2 | (2-12) | 6.0% |
| 3-dhBB(2F,3F)-O2 | (2-13) | 5.0% |
| 5-HH-O1 | (3-1) | 4.0% |
| 3-HH-V | (3-1) | 25.0% |
| 3-HH-VFF | (3-1) | 3.0% |
| 1-BB-3 | (3-3) | 6.0% |
| 3-HHEH-3 | (3-4) | 3.0% |
| V-HHB-1 | (3-5) | 5.0% |
| V2-HHB-1 | (3-5) | 3.0% |

The composition having a negative dielectric anisotropy described above was prepared and its characteristics were measured.

NI=74.6° C.; Tc<−20° C.; Δn=0.114; Δ∈=−2.6; Vth=2.37 V.

To the composition, a compound being compound (4-1) below was added in a proportion of 0.1 wt %, and a compound being compound (4-18) below was added in a proportion of 0.2 wt %.

| | |
|---|---|
| MAC-B(2F)B-MAC | (4-1) |
| AC-VO-BB(F)B-OV-AC | (4-18) |

The composition after addition was irradiated with UV light, and then its voltage holding ratios VHR-2a and VHR-3a were measured.

VHR-2a=97.4%; VHR-3a=59.4%.

### Example M8

| | | |
|---|---|---|
| 5-HBB(F)B(F)B-2 | (1-2-2) | 0.4% |
| V2-BB(2F,3F)-O2 | (2-4) | 10.0% |
| 1V2-BB(2F,3F)-O2 | (2-4) | 4.0% |
| 1V2-BB(2F,3F)-O4 | (2-4) | 4.0% |
| V-HHB(2F,3F)-O1 | (2-6) | 6.0% |
| V-HHB(2F,3F)-O2 | (2-6) | 10.0% |
| V-HHB(2F,3F)-O4 | (2-6) | 5.0% |
| 3-DhH1OB(2F,3F)-O2 | (2-11) | 3.0% |
| 3-HHB(2F,3CL)-O2 | (2-15) | 3.0% |
| 5-HBB(2F,3CL)-O2 | (2-16) | 3.0% |
| 3-H1OCro(7F,8F)-5 | (2-17) | 3.0% |
| 3-HH1OCro(7F,8F)-5 | (2-18) | 3.0% |
| 3-HH-V | (3-1) | 29.0% |
| 1-BB-3 | (3-3) | 6.0% |
| V-HHB-1 | (3-5) | 7.0% |
| 3-HBB-2 | (3-6) | 3.6% |

The composition having a negative dielectric anisotropy described above was prepared and its characteristics were measured.

NI=75.0° C.; Tc<−20° C.; Δn=0.105; Δ∈=−3.0; Vth=2.23 V.

To the composition, a compound being compound (4-18) below was added in a proportion of 0.3 wt %.

| | |
|---|---|
| AC-VO-BB(F)B-OV-AC | (4-18) |

The composition after addition was irradiated with UV light, and then its voltage holding ratios VHR-2a and VHR-3a were measured.

VHR-2a=96.9%; VHR-3a=58.7%.

### Example M9

| | | |
|---|---|---|
| 2-BB(2F,5F)BB-5 | (1-1-4) | 0.5% |
| 2-BB(2F,5F)B(2F)B-5 | (1-1-5) | 0.5% |
| V2-HB(2F,3F)-O2 | (2-1) | 5.0% |
| 3-H2B(2F,3F)-O2 | (2-2) | 9.0% |
| V-HHB(2F,3F)-O2 | (2-6) | 12.0% |
| 2-HH1OB(2F,3F)-O2 | (2-8) | 7.0% |
| 3-HH1OB(2F,3F)-O2 | (2-8) | 12.0% |
| 3-HDhB(2F,3F)-O2 | (2-10) | 3.0% |
| 2-HH-3 | (3-1) | 22.0% |
| 3-HH-V | (3-1) | 8.0% |
| 1-BB-3 | (3-3) | 9.0% |
| 3-HHB-1 | (3-5) | 3.0% |
| 3-B(F)BB-2 | (3-7) | 3.0% |
| 3-HB(F)HH-5 | (3-10) | 3.0% |
| 3-HB(F)BH-3 | (3-12) | 3.0% |

The composition having a negative dielectric anisotropy described above was prepared and its characteristics were measured.

NI=80.4° C.; Tc<−20° C.; Δn=0.095; Δ∈=−2.8; Vth=2.35 V.

To the composition, a compound being compound (4-18) below was added in a proportion of 0.4 wt %.

| | |
|---|---|
| MAC-BB(F)B-OV-MAC | (4-18) |

The composition after addition was irradiated with UV light, and then its voltage holding ratios VHR-2a and VHR-3a were measured.

VHR-2a=96.8%; VHR-3a=57.6%.

### Example M10

| | | |
|---|---|---|
| 5-HBB(F)B(2F)BH-5 | (1-3-1) | 0.5% |
| 1V2-HB(2F,3F)-O2 | (2-1) | 4.5% |
| 5-H2B (2F,3F)-O2 | (2-2) | 9.0% |
| 5-HHB(2F,3F)-O2 | (2-6) | 3.0% |
| V-HHB(2F,3F)-O2 | (2-6) | 6.0% |
| 2-HH1OB(2F,3F)-O2 | (2-8) | 7.0% |
| 3-HH1OB(2F,3F)-O2 | (2-8) | 12.0% |
| 2-HHB(2F,3CL)-O2 | (2-15) | 3.0% |
| 4-HHB(2F,3CL)-O2 | (2-15) | 3.0% |
| 2-HH-3 | (3-1) | 22.0% |
| 3-HH-V | (3-1) | 8.0% |
| 1-BB-3 | (3-3) | 10.0% |
| 3-HHB-1 | (3-5) | 3.0% |
| 3-HB(F)HH-5 | (3-10) | 3.0% |
| 3-HB(F)BH-3 | (3-12) | 3.0% |
| 2-BB(2F,3F)B-3 | (-) | 3.0% |

The composition having a negative dielectric anisotropy described above was prepared and its characteristics were measured.

NI=81.7° C.; Tc<−20° C.; Δn=0.094; Δ∈=−2.8; Vth=2.39 V.

To the composition, a compound being compound (4-2) below was added in a proportion of 0.1 wt %, and a compound being compound (4-18) below was added in a proportion of 0.1 wt %.

| | |
|---|---|
| MAC-VO-BB-OV-MAC | (4-2 ) |
| AC-VO-BB(F)B-OV-AC | (4-18) |

The composition after addition was irradiated with UV light, and then its voltage holding ratios VHR-2a and VHR-3a were measured.

VHR-2a=97.0%; VHR-3a=62.9%.

### Example M11

| | | |
|---|---|---|
| 5-BB(F)B(F)B(2F)-2 | (1-1-6) | 0.5% |
| 3-HB(2F,3F)-O4 | (2-1) | 5.0% |
| V-HB(2F,3F)-O2 | (2-1) | 4.0% |
| V2-BB(2F,3F)-O2 | (2-4) | 7.0% |
| 1V2-BB(2F,3F)-O2 | (2-4) | 5.5% |
| 2O-B(2F,3F)B(2F,3F)-O6 | (2-5) | 3.0% |
| V-HHB(2F,3F)-O2 | (2-6) | 10.0% |
| 3-HH2B(2F,3F)-O2 | (2-7) | 3.0% |
| 3-HH1OB(2F,3F)-O2 | (2-8) | 10.0% |
| 3-HH-V | (3-1) | 27.0% |
| 4-HH-V1 | (3-1) | 6.0% |
| 3-HH-2V1 | (3-1) | 3.0% |
| 3-HBB-2 | (3-6) | 7.0% |
| 5-HBB(F)B-2 | (3-13) | 3.0% |
| 2-BB(2F,3F)B-3 | (-) | 6.0% |

The composition having a negative dielectric anisotropy described above was prepared and its characteristics were measured.

NI=79.8° C.; Tc<−20° C.; Δn=0.112; Δ∈=−3.0; Vth=2.33 V.

To the composition, a compound being compound (4-3) below was added in a proportion of 0.1 wt %, and a compound being compound (4-18) below was added in a proportion of 0.2 wt %.

| | |
|---|---|
| MAC-B(F)B-MAC | (4-3) |
| MAC-BB(F)B-OV-MAC | (4-18) |

The composition after addition was irradiated with UV light, and then its voltage holding ratios VHR-2a and VHR-3a were measured.

VHR-2a=96.7%; VHR-3a=57.4%.

### Example M12

| | | |
|---|---|---|
| 5-BB(F)B(F)B(F)-3 | (1-1-7) | 0.2% |
| 3-HB(2F,3F)-O2 | (2-1) | 5.0% |
| V-HB(2F,3F)-O4 | (2-1) | 4.0% |
| 5-BB(2F,3F)-O2 | (2-4) | 6.0% |
| V2-BB(2F,3F)-O2 | (2-4) | 7.0% |
| 3-B(2F,3F)B(2F,3F)-O2 | (2-5) | 3.0% |
| V-HHB(2F,3F)-O2 | (2-6) | 10.0% |
| 3-HH1OB(2F,3F)-O2 | (2-8) | 10.0% |
| 4-HBB(2F,3F)-O2 | (2-12) | 3.0% |
| 3-HBB(2F,3CL)-O2 | (2-16) | 3.0% |
| 3-HH-O1 | (3-1) | 3.0% |
| 3-HH-V | (3-1) | 24.0% |
| 3-HB-O2 | (3-2) | 3.0% |
| V-HHB-1 | (3-5) | 6.8% |
| 3-BB(F)B-5 | (3-8) | 3.0% |
| 5-HBB(F)B-2 | (3-13) | 4.0% |
| 2-BB(2F,3F)B-3 | (-) | 5.0% |

The composition having a negative dielectric anisotropy described above was prepared and its characteristics were measured.

NI=77.7° C.; Tc<−20° C.; Δn=0.117; Δ∈=−3.1; Vth=2.30 V.

To the composition, a compound being compound (4-2) below was added in a proportion of 0.3 wt %, and a compound being compound (4-23) below was added in a proportion of 0.1 wt %.

| | |
|---|---|
| AC—VO—BB—OV—AC | (4-2) |
| 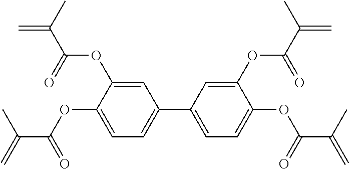 [SMILES: C=C(C)C(=O)Oc1ccc(-c2ccc(OC(=O)C(=C)C)c(OC(=O)C(=C)C)c2)cc1OC(=O)C(=C)C] | (4-23) |

The composition after addition was irradiated with UV light, and then its voltage holding ratios VHR-2a and VHR-3a were measured.

VHR-2a=96.6%; VHR-3a=54.9%.

### Example M13

| | | |
|---|---|---|
| 5-HBB(F)BB-2 | (1-2-1) | 0.3% |
| 5-HBB(F)B(F)B-2 | (1-2-2) | 0.3% |
| 3-BB(2F,3F)-O4 | (2-4) | 5.0% |
| V2-BB(2F,3F)-O2 | (2-4) | 12.0% |
| 1V2-BB(2F,3F)-O1 | (2-4) | 4.0% |
| 3-HHB (2F, 3F)-O2 | (2-6) | 5.0% |
| V-HHB(2F,3F)-O1 | (2-6) | 6.0% |
| V-HHB(2F,3F)-O2 | (2-6) | 12.0% |
| 3-DhHB(2F,3F)-O2 | (2-9) | 5.0% |
| 3-HEB(2F,3F)B(2F,3F)-O2 | (2-14) | 5.0% |
| 3-HH-V | (3-1) | 22.4% |
| 4-HH-V | (3-1) | 3.0% |
| 5-HH-V | (3-1) | 6.0% |
| 7-HB-1 | (3-2) | 3.0% |
| V-HHB-1 | (3-5) | 5.0% |
| 3-HBB-2 | (3-6) | 3.0% |
| 2-BB(F)B-3 | (3-8) | 3.0% |

The composition having a negative dielectric anisotropy described above was prepared and its characteristics were measured.

NI=77.7° C.; Tc<−20° C.; Δn=0.106; Δ∈=−2.9; Vth=2.25 V.

To the composition, a compound being compound (4-2) below was added in a proportion of 0.2 wt %.

| | |
|---|---|
| AC-VO-BB-MAC | (4-2) |

The composition after addition was irradiated with UV light, and then its voltage holding ratios VHR-2a and VHR-3a were measured.

VHR-2a=97.7%; VHR-3a=66.4%.

The compositions in Example M1 to Example M13 were found to have a larger voltage holding ratio (VHR-2a and VHR-3a) in comparison with the composition in Comparative Example M1. Therefore, the liquid crystal composition of the invention can be concluded to have superb characteristics.

### INDUSTRIAL APPLICABILITY

A liquid crystal composition of the invention satisfies at least one of characteristics or has a suitable balance regarding two of the characteristics in the characteristics such as a high maximum temperature, a low minimum temperature, a small viscosity, a suitable optical anisotropy, a large negative dielectric anisotropy, a large specific resistance, a high stability to ultraviolet light and a high stability to heat. A liquid crystal display device including the composition has characteristics such as a short response time, a large voltage holding ratio, a low threshold voltage, a large contrast ratio and a long service life, and therefore can be used for a liquid crystal projector, a liquid crystal television and so forth.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

What is claimed is:

1. A liquid crystal composition that has a negative dielectric anisotropy, and contains at least one compound selected from the group of compounds represented by formula (1) as a first component: 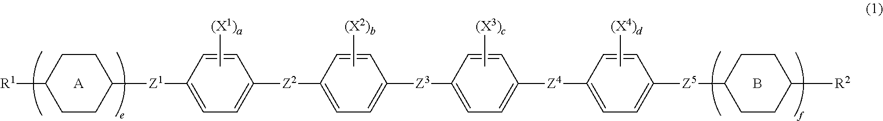
wherein in formula (1), R¹ and R² are independently alkyl having 1 to 12 carbons, alkoxy having 1 to 12 carbons, alkenyl having 2 to 12 carbons, or alkenyl having 2 to 12 carbons in which at least one hydrogen is replaced by fluorine; ring A and ring B are independently 1,4-phenylene, 1,4-cyclohexylene, 1,4-cyclohexenylene, 1,3-dioxane-2,5-diyl, tetrahydropyran-2,5-diyl, or 1,4-phenylene in which at least one hydrogen is replaced by fluorine, chlorine or methyl; X¹, X², X³ and X⁴ are independently fluorine, chlorine or methyl; Z¹, Z², Z³, Z⁴ and Z⁵ are independently a single bond, —CH₂CH₂—, —CH₂O—, —OCH₂—, —COO— or —OCO—; a, b, c and d are independently 0, 1, 2, 3 or 4; and e and f are independently 0 or 1.

2. The liquid crystal composition of claim 1, containing at least one compound selected from the group of compounds represented by formula (1-1) to formula (1-3) as the first component: 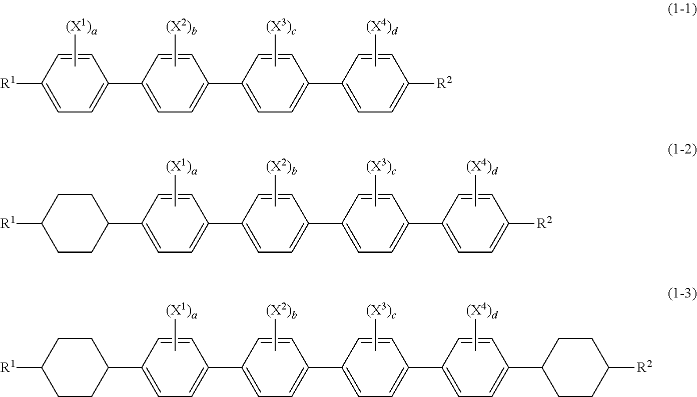
wherein in formula (1-1) to formula (1-3), R¹ and R² are independently alkyl having 1 to 12 carbons, alkoxy having 1 to 12 carbons, alkenyl having 2 to 12 carbons, or alkenyl having 2 to 12 carbons in which at least one hydrogen is replaced by fluorine; X¹, X², X³ and X⁴ are independently fluorine, chlorine or methyl; and a, b, c and d are independently 0, 1, 2, 3 or 4.

3. The liquid crystal composition of claim 1, containing at least one compound selected from the group of compounds represented by formula (1-1-1) to formula (1-1-8), formula (1-2-1), formula (1-2-2) and formula (1-3-1) as the first component: 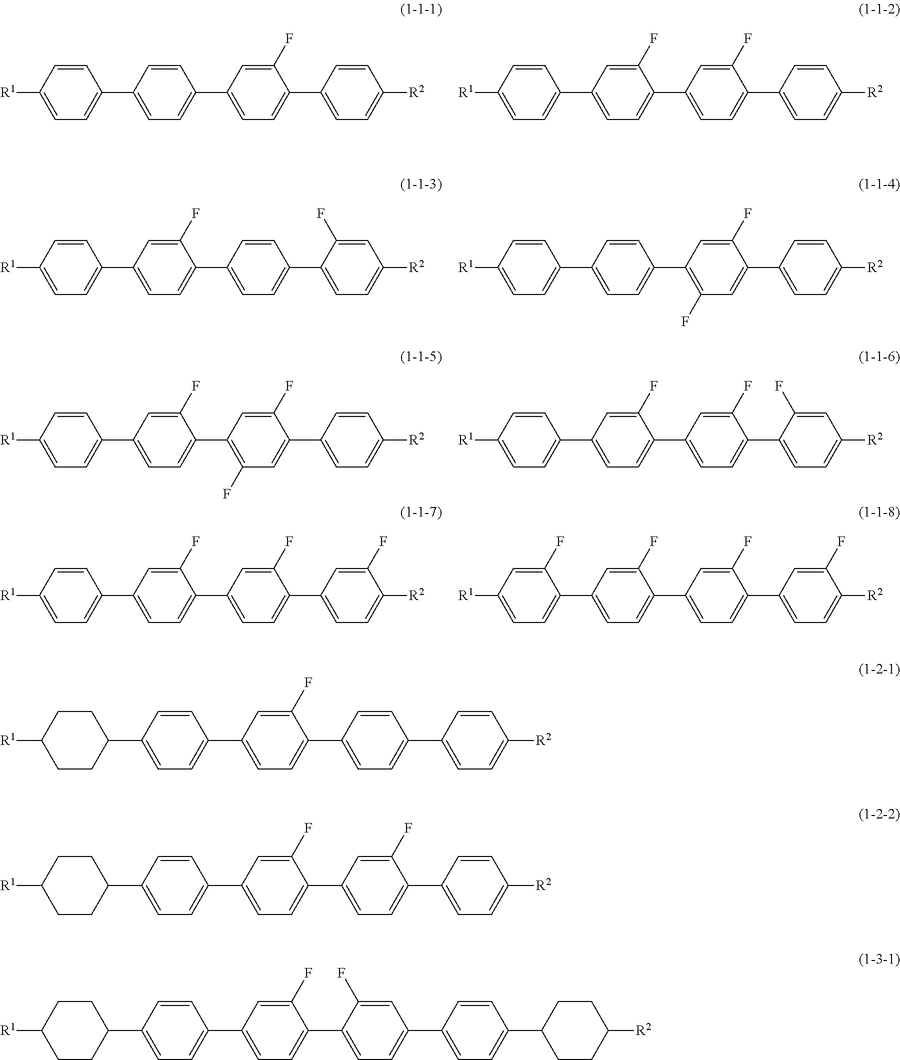
wherein in formula (1-1-1) to formula (1-1-8), formula (1-2-1), formula (1-2-2) and formula (1-3-1), R¹ and R² are independently alkyl having 1 to 12 carbons, alkoxy having 1 to 12 carbons, alkenyl having 2 to 12 carbons, or alkenyl having 2 to 12 carbons in which at least one hydrogen is replaced by fluorine.

4. The liquid crystal composition of claim 1, wherein a proportion of the first component is in a range of 0.03 wt % to 10 wt % based on a weight of the liquid crystal composition.

5. The liquid crystal composition of claim 1, further containing at least one compound selected from the group of compounds represented by formula (2) as a second component: 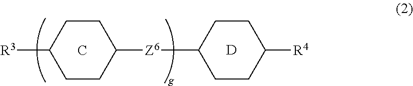
wherein in formula (2), R³ and R⁴ are independently alkyl having 1 to 12 carbons, alkoxy having 1 to 12 carbons, alkenyl having 2 to 12 carbons or alkenyloxy having 2 to 12 carbons; ring C is 1,4-cyclohexylene, tetrahydropyran-2,5-diyl, 1,4-phenylene, or 1,4-phenylene in which at least one hydrogen is replaced by fluorine or chlorine; ring D is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl or 7,8-difluorochroman-2,6-diyl; Z⁶ is a single bond, —CH₂CH₂—, —CH₂O—, —OCH₂—, —COO— or —OCO—; and g is 1, 2 or 3, and when g is 3, ring C is 1,4-cyclohexylene or tetrahydropyran-2,5-diyl.

6. The liquid crystal composition of claim 5, containing at least one compound selected from the group of compounds represented by formula (2-1) to formula (2-18) as the second component: 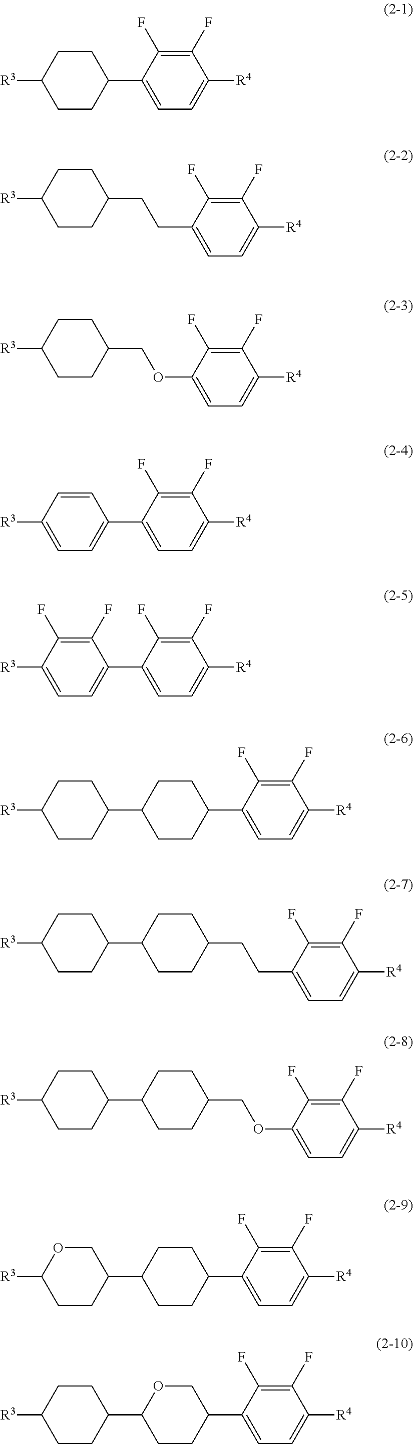 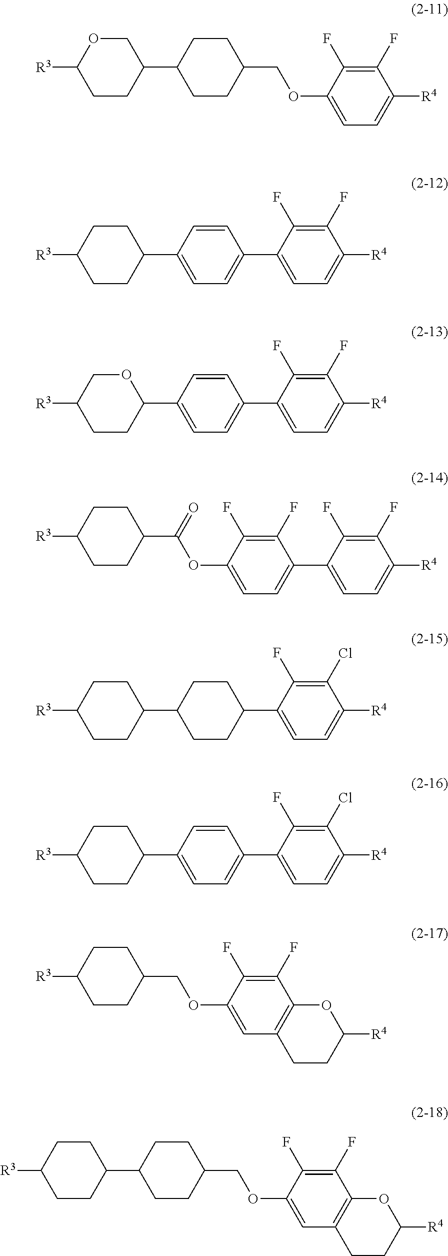
wherein in formula (2-1) to formula (2-18), R³ and R⁴ are independently alkyl having 1 to 12 carbons, alkoxy having 1 to 12 carbons, alkenyl having 2 to 12 carbons, or alkenyloxy having 2 to 12 carbons.

7. The liquid crystal composition of claim 5, wherein a proportion of the second component is in a range of 10 wt % to 90 wt % based on a weight of the liquid crystal composition.

8. The liquid crystal composition of claim 1, further containing at least one compound selected from the group of compounds represented by formula (3) as a third component: 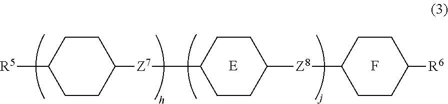
wherein in formula (3), R⁵ and R⁶ are independently alkyl having 1 to 12 carbons, alkoxy having 1 to 12 carbons, alkenyl having 2 to 12 carbons, or alkenyl having 2 to 12 carbons in which at least one hydrogen is replaced by fluorine; ring E and ring F are independently 1,4-cyclohexylene, 1,4-phenylene or 2-fluoro-1,4-phenylene; Z⁷ and Z⁸ are independently a single bond, —CH₂CH₂—, —CH₂O—, —OCH₂—, —COO— or —OCO—; h is 0 or 1; and j is 1 or 2.

9. The liquid crystal composition of claim 5, further containing at least one compound selected from the group of compounds represented by formula (3) as a third component: 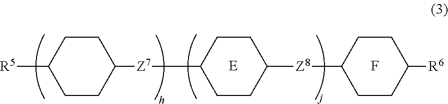
wherein in formula (3), R⁵ and R⁶ are independently alkyl having 1 to 12 carbons, alkoxy having 1 to 12 carbons, alkenyl having 2 to 12 carbons, or alkenyl having 2 to 12 carbons in which at least one hydrogen is replaced by fluorine; ring E and ring F are independently 1,4-cyclohexylene, 1,4-phenylene or 2-fluoro-1,4-phenylene; Z⁷ and Z⁸ are independently a single bond, —CH₂CH₂—, —CH₂O—, —OCH₂—, —COO— or —OCO—; h is 0 or 1; and j is 1 or 2.

10. The liquid crystal composition of claim 8, containing at least one compound selected from the group of compounds represented by formula (3-1) to formula (3-13) as the third component: 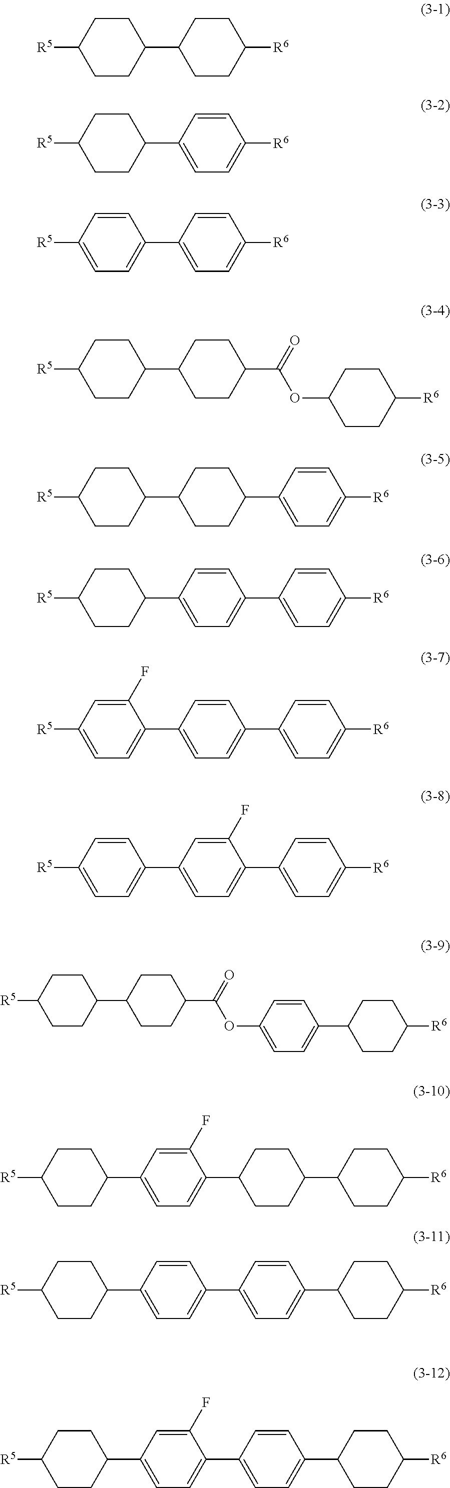 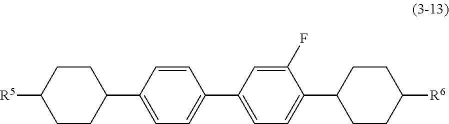
wherein in formula (3-1) to formula (3-13), R⁵ and R⁶ are independently alkyl having 1 to 12 carbons, alkoxy having 1 to 12 carbons, alkenyl having 2 to 12 carbons, or alkenyl having 2 to 12 carbons in which at least one hydrogen is replaced by fluorine.

11. The liquid crystal composition of claim 9, containing at least one compound selected from the group of compounds represented by formula (3-1) to formula (3-13) as the third component: 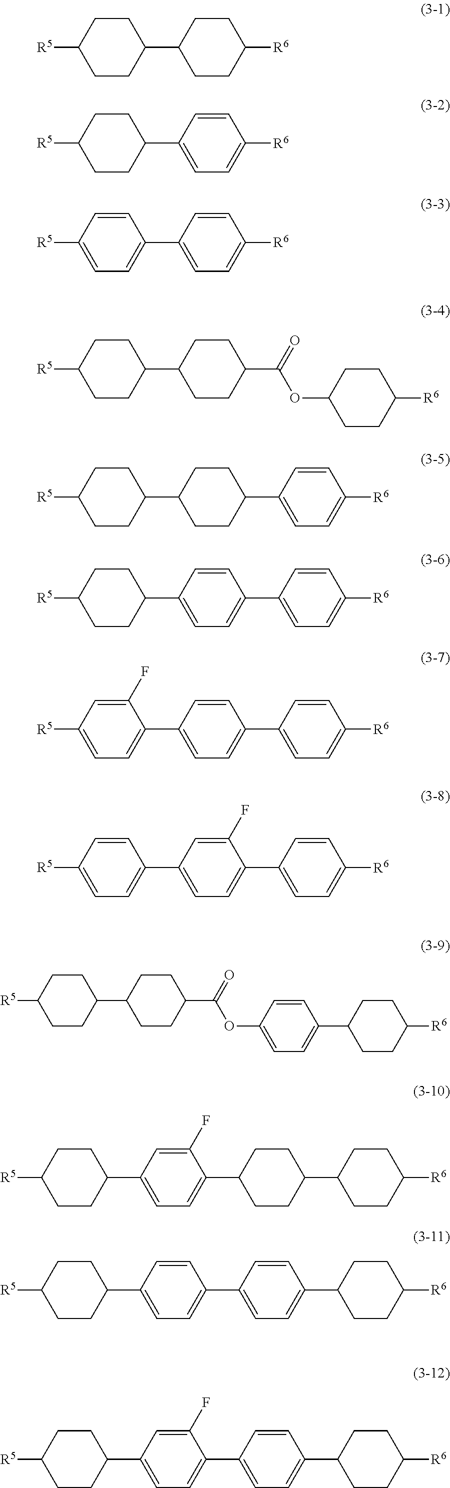 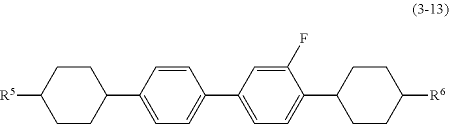
wherein in formula (3-1) to formula (3-13), R⁵ and R⁶ are independently alkyl having 1 to 12 carbons, alkoxy having 1 to 12 carbons, alkenyl having 2 to 12 carbons, or alkenyl having 2 to 12 carbons in which at least one hydrogen is replaced by fluorine.

12. The liquid crystal composition of claim 8, wherein a proportion of the third component is in a range of 10 wt % to 90 wt % based on a weight of the liquid crystal composition.

13. The liquid crystal composition of claim 9, wherein a proportion of the third component is in a range of 10 wt % to 90 wt % based on a weight of the liquid crystal composition.

14. The liquid crystal composition of claim 1, further containing at least one polymerizable compound selected from the group of compounds represented by formula (4) as an additive component: 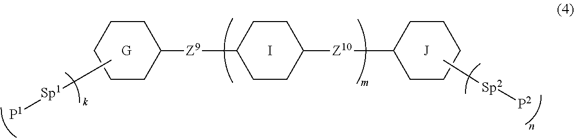
wherein in formula (4), P¹ and P² are independently a polymerizable group selected from the group of groups represented by formula (P-1), formula (P-2) and formula (P-3); 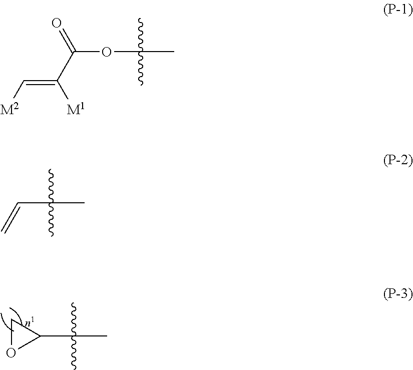
wherein in formula (P-1), M¹ and M² are independently hydrogen, fluorine, methyl or trifluoromethyl;
in formula (P-3), n¹ is 1, 2, 3 or 4; Sp¹ and Sp² are independently a single bond or alkylene having 1 to 12 carbons, and in the alkylene, at least one —CH₂— may be replaced by —O—, —S—, —NH—, —CO—, —COO—, —OCO— or —OCOO—, at least one —CH₂—CH₂— may be replaced by —CH═CH— or —C≡C—, and at least one hydrogen may be replaced by halogen or —C≡N; Z⁹ is a single bond, —CH₂CH₂—, —CH₂O—, —OCH₂—, —COO—, —OCO—, —CO—CR⁷═CR⁸—, —CR⁸═CR⁷—CO—, —OCO—CR⁷═CR⁸—, —CR⁸═CR⁷—COO—, —CR⁷═CR⁸— or —C(═CR⁷R⁸)—; Z¹⁰ is a single bond, —CH₂CH₂—, —CH₂O—, −OCH₂—, —COO— or —OCO—; R⁷ and R⁸ are independently hydrogen, halogen, alkyl having 1 to 10 carbons, or alkyl having 1 to 10 carbons in which at least one hydrogen is replaced by fluorine; ring G and ring J are independently cyclohexyl, phenyl, 2-fluorophenyl, 3-fluorophenyl, 2,3-difluorophenyl, 2-methylphenyl, 3-methylphenyl, 2-(trifluoromethyl)phenyl, 3-(trifluoromethyl)phenyl or 2-naphthyl; ring I is 1,4-cyclohexylene, 1,4-phenylene, naphthalene-2,6-diyl, 2-fluoro-1,4-phenylene, 2,3-difluoro-1,4-phenylene, 2,5-difluoro-1,4-phenylene, 2-methyl-1,4-phenylene or 2-trifluoromethyl-1,4-phenylene; m is 0, 1 or 2; k is 1, 2 or 3; n is 1, 2 or 3, and a sum of k and n is 4 or less; and when both P¹ and P² are a group represented by formula (P-2), at least one of Sp¹ and Sp² is alkylene in which at least one —CH₂— is replaced by —O—, —COO—, —OCO— or —OCOO—.

15. The liquid crystal composition of claim 14, containing at least one polymerizable compound selected from the group of compounds represented by formulas (4-1) to (4-26) as the additive component: 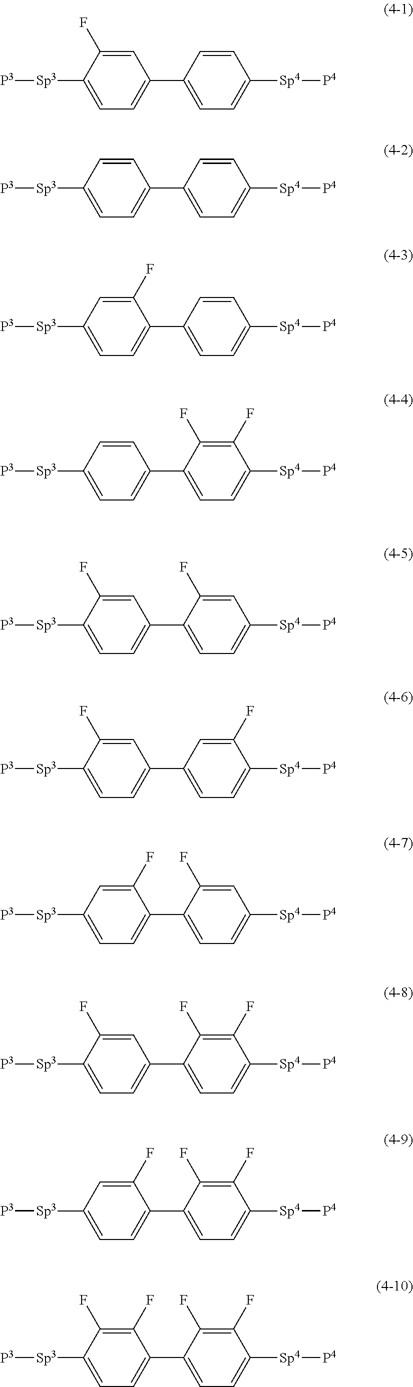 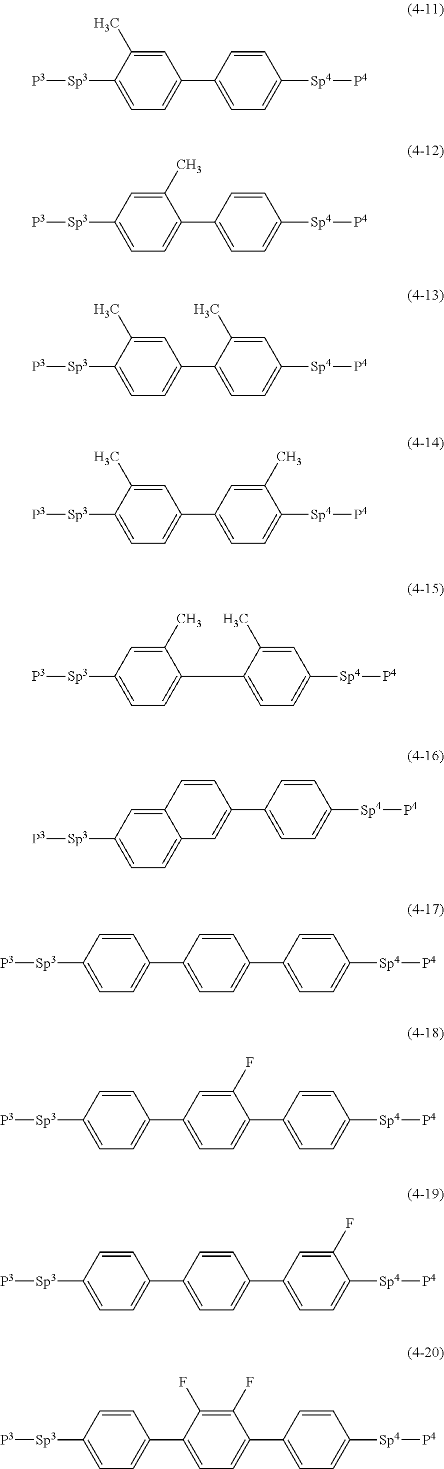 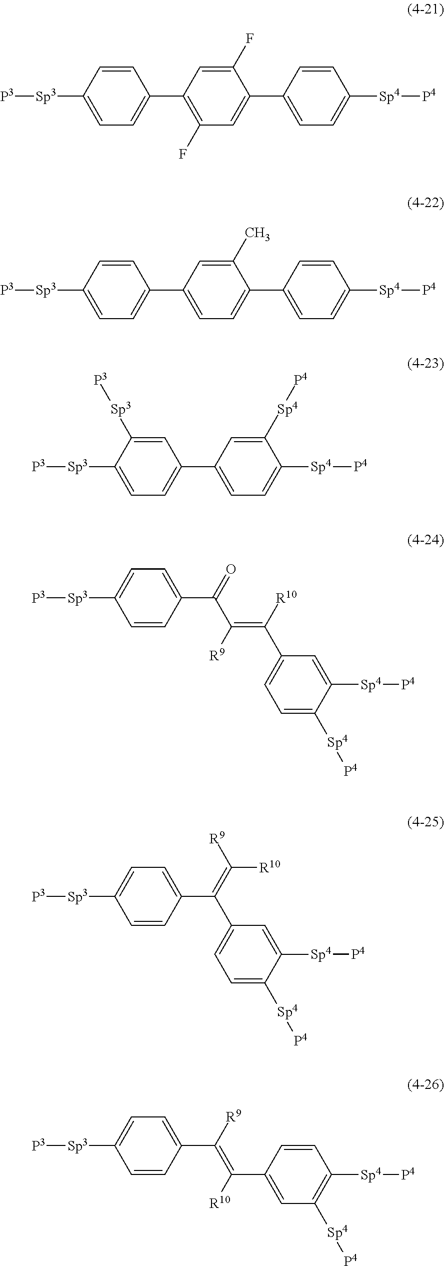
wherein in formula (4-1) to formula (4-26), P³ and P⁴ are independently a group represented by (P-1); 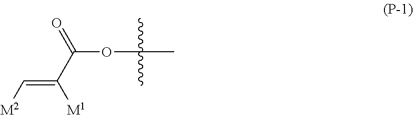
wherein in formula (P-1), M¹ and N² are independently hydrogen, fluorine, methyl or trifluoromethyl; Sp³ and Sp⁴ are independently a single bond or alkylene having 1 to 12 carbons, and in the alkylene, at least one —CH₂— may be replaced by —O—, —COO—, —OCO— or —OCOO—, at least one —CH₂—CH₂— may be replaced by —CH═CH— or —C≡C—, and at least one hydrogen may be replaced by fluorine or chlorine; and R⁹ and R¹⁰ are independently hydrogen, fluorine, chlorine, alkyl having 1 to 3 carbons, or alkyl having 1 to 3 carbons in which at least one hydrogen is replaced by fluorine.

16. The liquid crystal composition of claim 14, wherein a proportion of addition of the additive component is in a range of 0.03 wt % to 10 wt % based on a weight of the liquid crystal composition before addition.

17. A compound represented by formula (1-2) or formula (1-3): 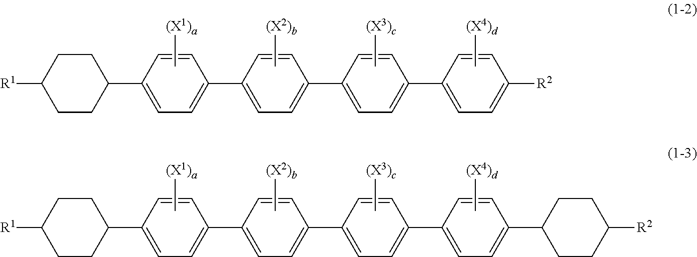
wherein in formula (1-2) and formula (1-3), R¹ and R² are independently alkyl having 1 to 12 carbons, alkoxy having 1 to 12 carbons, alkenyl having 2 to 12 carbons, or alkenyl having 2 to 12 carbons in which at least one hydrogen is replaced by fluorine; X′, X², X³ and X⁴ are independently fluorine, chlorine or methyl; and a, b, c and d are independently 0, 1, 2, 3 or 4.

18. A liquid crystal display device including the liquid crystal composition of claim 1.

19. The liquid crystal display device of claim 18, having an operating mode being an IPS mode, a VA mode, an FFS mode or an FPA mode, and having a driving mode being an active matrix mode.

20. A liquid crystal display device having a polymer sustained alignment mode, containing the liquid crystal composition of claim 14 in which the polymerizable compound has been polymerized.
